(19) United States
(12) Patent Application Publication
(10) Pub. No.: US 2009/0208685 A1
(43) Pub. Date: Aug. 20, 2009

(54) Packaging film and method of decreasing scalping of polar cyclic compounds

(75) Inventors: Brian Patrick Rivers, Simpsonville, SC (US); George Douglas Bolden, Simpsonville, SC (US); Michael Daniel Grah, Greenville, SC (US)

Correspondence Address: Ashley D. Wilson;Sealed Air Corporation (US), P. O. Box 464, Duncan, SC, 29334, US

(73) Assignee: Sealed Air Corporation (US)

(21) Appl. No.: 12/378,439

(22) Filed: Feb. 13, 2009

Related U.S. Application Data
(60) Provisional application No. 61/201,891, filed on Dec. 16, 2008.
(60) Provisional application No. 61/066,441, filed on Feb. 20, 2008.

(51) Int. Cl. B32B 1/08; B32B 27/08; B32B 27/10

(52) U.S. Cl. 428/36.91; 428/515; 428/461; 428/512

(57) ABSTRACT

The presently disclosed subject matter is directed to packaging films that include semi-crystalline cyclic olefin copolymers, amorphous cyclic olefin copolymers, and/or cyclic olefin polymers present in the sealant layer and/or in the layer adjacent to the sealant layer such that the film exhibits decreased scalping of essential oils, flavor compounds, antibacterial additives, antifungal additives, and the like from products packaged using the disclosed films. More particularly, the presently disclosed films minimally scalp polar cyclic compounds from the packaged product. The presently disclosed subject matter is further directed to making and using the disclosed films.

### CROSS REFERENCE TO RELATED APPLICATIONS

The subject application claims priority to U.S. Provisional Patent Application Nos. 61/201,891 and 61/066,441, filed Dec. 16, 2008 and Feb. 20, 2008, respectively.

### TECHNICAL FIELD

The presently disclosed subject matter relates to the field of plastic fabrication and uses. More specifically, the presently disclosed subject matter relates to plastic films that have a sealant layer and/or a layer adjacent to a sealant layer that minimally scalps essential oils, flavor compounds, antibacterial additives, antifungal additives, insecticides, and the like from products packaged using the disclosed films, and related methods and packaged products.

### BACKGROUND

Packaged products often contain flavor, aroma, antibacterial compounds, biocides, and the like to enhance their value and/or efficacy. However, it is common in the art for packaging materials to scalp such flavors, aromas, antibacterial compounds, biocides, and the like from the packaged product. Typically, in order to compensate for the scalping, additional flavors, aromas, and the like are added into the packaged product, which can prove costly and inefficient. As a result, these compositions often require special packaging formats that contain and preserve the packaged product.

In particular, these packages can have internal layers that minimize scalping of the essential oils, flavor compounds, etc. Typical scalp-resistant polymers (such as, for example, BAREX® ((available from Ineos Barex, Delaware City, Del., United States of America)), acetal resin, and/or biaxially oriented PET) can be blow molded into useful rigid containers, but are difficult to incorporate into multilayer films useful for flexible packaging formats. In addition, these resins have relatively high melting temperatures that make them inappropriate for use as sealant layers, and/or layers adjacent to a sealant layer. Further, these resins are chemically incompatible with, and cannot be easily joined to, low cost polyethylene-based products.

Accordingly, there is a need in the art for further improvements in packaging films and film structures, particularly those that exhibit resistance to scalping of polar cyclic compounds. More particularly, there is a need in the art for packaging films that exhibit low scalping of polyphenols, oxygenated derivatives of cyclic terpenes, and other polar cyclic compounds from a packaged product, while also providing desirable physical characteristics.

### SUMMARY

There is a need in the art for an improved packaging film assuring lower scalping of package contents, and related methods of making and using the same.

In some embodiments, the presently disclosed subject matter is directed to a packaging film comprising: (a) a sealant layer comprising at least 25 weight % semi-crystalline cyclic olefin copolymer, amorphous cyclic olefin copolymer, cyclic olefin polymer, or combinations thereof based on the total weight of the layer; or (b) a layer adjacent to a sealant layer, the adjacent layer comprising at least 25 weight % semi-crystalline cyclic olefin copolymer, amorphous cyclic olefin copolymer, cyclic olefin polymer, or combinations thereof based on the total weight of the layer; or (c) both layers (a) and (b); wherein the film scalps not more than about 1 to 90% of the polar cyclic compounds in a composition in contact with the film. In some embodiments, layers (a) and/or (b) can further comprise not more than 75 weight % of a polyolefin, preferably medium density polyethylene.

In some embodiments, the presently disclosed subject matter is directed to a method of minimally scalping polar cyclic compounds from a packaged product, the method comprising packaging the product in a packaging film comprising: (a) a sealant layer comprising at least 25 weight % semi-crystalline cyclic olefin copolymer, amorphous cyclic olefin copolymer, cyclic olefin polymer, or combinations thereof based on the total weight of the layer; or (b) a layer adjacent to a sealant layer, the adjacent layer comprising at least 25 weight % semi-crystalline cyclic olefin copolymer, amorphous cyclic olefin copolymer, cyclic olefin polymer, or combinations thereof based on the total weight of the layer; or (c) both (a) and (b); wherein the film scalps not more than about 1 to 90% of the polar cyclic compounds in said packaged product. In some embodiments, layers (a) and/or (b) can further comprise not more than 75 weight % of a polyolefin, preferably medium density polyethylene.

In some embodiments, the presently disclosed subject matter is directed to a packaged product comprising a film surrounding a product, wherein the film comprises: (a) a sealant layer comprising at least 25 weight % semi-crystalline cyclic olefin copolymer, amorphous cyclic olefin copolymer, cyclic olefin polymer, or combinations thereof based on the total weight of the layer; or (b) a layer adjacent to a sealant layer comprising at least 25 weight % semi-crystalline cyclic olefin copolymer, amorphous cyclic olefin copolymer, cyclic olefin polymer, or combinations thereof based on the total weight of the layer; or (c) both (a) and (b); wherein the film scalps not more than about 1 to 90% of the polar cyclic compounds initially contained in the product. In some embodiments, layers (a) and/or (b) can further comprise not more than 75 weight % of a polyolefin, preferably medium density polyethylene.

### BRIEF DESCRIPTION OF THE DRAWINGS

FIG. 1 is a series of line graphs representing an extended time study of the percent Triclosan remaining in solution taken at 0 to 14 day time points after exposure to a variety of monolayer films.

FIG. 2 is a series of line graphs depicting a time study of the percent Triclosan remaining in solution after exposure to a variety of a monolayer films taken at 0 to 140 hour time points.

FIG. 3 is a bar graph illustrating the percent Triclosan remaining in solution after 20 hours of exposure to a variety of monolayer films.

FIG. 4 is a series of line graphs depicting a time study of the percent Triclosan remaining in solution after exposure to several monolayer films taken at 0 to 21 hour time points.

FIG. 5 is a series of line graphs depicting a time study of the percent Triclosan remaining in solution after exposure to several monolayer films taken at 0 to 21 hour time points.

FIG. 6 is a series of line graphs depicting the percentage of Anethole remaining in solution after exposure to several monolayer films taken at 0 to 11 hour time points.

FIG. 7 is a series of line graphs depicting the percentage butylated hydroxytoluene remaining in solution after exposure to several monolayer films taken at 0 to 11 hour time points.

FIGS. 8-11 are bar graphs depicting the amount of Triclosan, Menthol, Anethole, and Limonene, respectively, scalped after exposure to a variety of films.

FIGS. 12-15 are bar graphs depicting the amount of Triclosan, Menthol, Limonene, and Anethole, respectively, scalped after exposure to a variety of films.

### DETAILED DESCRIPTION

### 1. General Considerations

The packaging materials of the presently disclosed subject matter can comprise a film that can be sealed to a substrate or to itself. The film includes cyclic olefin copolymers and/or cyclic olefin polymers present in the sealant layer and/or in the layer adjacent to the sealant layer such that the film is capable of forming a package that exhibits decreased scalping of polar cyclic compounds from a packaged product, as discussed in more detail herein below.

Particularly, it has now been surprisingly found that if the sealant layer and/or the layer adjacent to the sealant layer of a thermoplastic film comprises a cyclic olefin copolymer, cyclic olefin polymer, or a blend of cyclic olefin copolymer and cyclic olefin polymer, said layer will exhibit decreased scalping of polar cyclic compounds from the package contents. Said thermoplastic film can therefore be employed in the manufacture of a package wherein an article is wrapped in the thermoplastic film or is placed between a lower and an upper thermoplastic film, wherein at least one of said films comprises a sealing layer or layer adjacent to the sealing layer comprising the above blend. The incorporation of cyclic olefin copolymer and/or cyclic olefin polymer into the disclosed film has been found to not impair the sealing performance or other useful properties of the packaging film.

Accordingly, it is an object of the presently disclosed subject matter to provide packaging films that minimally scalp polar cyclic compounds from a packaged product, and methods of making and using the same. This object is achieved in whole or part by the presently disclosed subject matter.

### II. Definitions

While the following terms are believed to be understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” can refer to “one or more” when used in the subject specification, including the claims. Thus, for example, reference to “a bag” can include a plurality of such bags, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed packages and methods.

As used herein, the term “abuse layer” can refer to an outer film layer and/or an inner film layer, so long as the film layer serves to resist abrasion, puncture, and other potential causes of reduction of package integrity, as well as potential causes of reduction of package appearance quality. Abuse layers can comprise any polymer, so long as the polymer contributes to achieving an integrity goal and/or an appearance goal. In some embodiments, the abuse layer can comprise polyamide, ethylene/propylene copolymer (such as, but not limited to, nylon 6, nylon 6/6, amorphous nylon, and ethylene/propylene copolymer), and/or combinations thereof.

As used herein, the term “adjacent”, as applied to film layers, can refer to the positioning of two layers of the film either in contact with one another without any intervening layer or with a tie layer, adhesive, or other layer therebetween. The term “directly adjacent” can refer to adjacent layers that are in contact with another layer without any tie layer, adhesive, or other layer therebetween.

As used herein, the term “amorphous cyclic olefin copolymer” can refer to cyclic olefin copolymer having no long-range order of the components, or non-crystalline morphology.

As used herein, the terms “barrier” and/or “barrier layer” can refer to the ability of a film or film layer to serve as a barrier to one or more gases. For example, oxygen barrier layers can comprise, but are not limited to, ethylene/vinyl alcohol copolymer, polyvinyl chloride, polyvinylidene chloride, polyamide, polyester, polyacrylonitrile, and the like, as known to those of skill in the art.

As used herein, the term “bulk layer” can refer to any layer of a film that is present for the purpose of increasing the abuse-resistance, toughness, modulus, and the like, of a film. In some embodiments, bulk layers can comprise polymers that are inexpensive relative to other polymers in the film that provide some specific purpose unrelated to abuse-resistance, modulus, and the like. In some embodiments, bulk layers can comprise polyolefin; in some embodiments, ethylene/alpha-olefin copolymer, ethylene/alpha-olefin copolymer plastomer, low density polyethylene, linear low density polyethylene, and combinations thereof.

As used herein, the term “copolymer” can refer to polymers formed by the polymerization reaction of at least two different monomers. For example, the term “copolymer” can include the copolymerization reaction product of ethylene and an alpha-olefin, such as 1-hexene. However, in some embodiments the term “copolymer” can include, for example, the copolymerization of a mixture of ethylene, propylene, 1-hexene, and 1-octene.

As used herein, the terms “core” and “core layer” can refer to any internal film layer that has a primary function other than serving as an adhesive or compatibilizer for adhering two layers to one another. In some embodiments, the core layer or layers provide the multilayer film with a desired quality, such as for example, level of strength, modulus, optics, added abuse resistance, and/or specific impermeability.

As used herein, “cyclic olefin”, can refer to a compound containing a polymerizable carbon-carbon double bond that is either contained within an alicyclic ring, e.g., as in norbornene, or linked to an alicyclic ring, e.g., as in vinyl cyclohexane. Polymerization of the cyclic olefin provides a polymer comprising an alicyclic ring as part of or pendant to the polymer backbone. In some embodiments, the cyclic olefins can include, but are not limited to, norbornene, substituted norbornenes, cyclopropene, cyclo-butene, cyclopentene, methylcyclopentene, vinylcyclohexene, 5-vinyinorbornene, 5-methylnorbornene, 5-ethylidene-norbornene, 2-adamantylidene, 2-vinyl adamantane, tetra-cyclododecene, and/or combinations thereof.

As used herein, the term “cyclic olefin copolymer” and the like herein (e.g., cycloolefin copolymer) can refer to a copolymer formed by the polymerization of a cyclic olefin with a comonomer. An example of a cyclic olefin copolymer is ethylene/norbornene copolymer, such as that supplied by Ticona under the trademark TOPAS™, by Zeon Chemicals under the trademark ZEONOR™, and by Mitsui Chemicals under the trademark APEL™.

As used herein, the term “cyclic polymer” can refer to polymers that contain polymerized cyclic olefin units. Cyclic olefin polymers suitable with the presently disclosed subject matter can contain from about 0.1 to about 100 percent by weight polymerized cyclic olefin units; in some embodiments, from about 10 to about 99 by weight; in some embodiments, from about 50 to about 95 percent by weight, based on the total weight of the cyclic olefin polymer.

As used herein, the term “film” can include, but is not limited to, a laminate, sheet, web, coating, and/or the like, that can be used to package a product. The film can be rigid, semi-rigid, or flexible product, and can be adhered to a non-polymeric or non-thermoplastic substrate such as paper or metal to form a rigid, semi-rigid, or flexible product or composite.

As used herein, the term “flavonoid” can refer to polyphenols that have a carbon skeleton. Flavonoids have an acidic nature as a result of the phenol groups.

As used herein, the terms “lamination”, “laminate”, and/or “laminated film” can refer to the process and/or resulting product made by bonding together two or more films or a film and a non-polymeric or non-thermoplastic substrate, such as paper or metal. In some embodiments, lamination can be accomplished by joining layers with adhesives, joining with heat and pressure, and/or spread coating and extrusion coating. In some embodiments, the term “laminate” can also be inclusive of coextruded multilayer films that can comprise one or more tie layers. In some embodiments, the presently disclosed films can be adhered or bonded to metal foils (such as, for example, copper, aluminum, gold, silver, bronze, brass, and the like), a polymeric material, a paper product, or combinations thereof to form a laminate.

As used herein, the term “lignin” can refer to a highly polymerized and complex chemical compound especially common in woody plants. The cellulose walls of the wood become impregnated with lignin, a process called lignification, which greatly increases the strength and hardness of the cell and gives the necessary rigidity to the tree.

The term “medium density polyethylene” (MDPE) as used herein is defined to mean an ethylene-containing polymer having a density of from about 0.926 to about 0.940. MDPE is readily available, e.g., Dowlex™ 2027A from The Dow Chemical Company, and Nova 74B and Nova 14G from Nova Corporation, Sarnia, Ontario, Canada.

As used herein, the term “minimally scalping” can refer to the ability of a film to scalp less of a desired compound (such as, for example, polar cyclic compounds) compared to a control film or to prior art films. In some embodiments, the minimally scalping film will scalp less of the desired compound compared to comparable films lacking cyclic olefin copolymer and/or cyclic olefin polymer in the sealant layer and/or in the layer adjacent to the sealant layer. In some embodiments, the minimally scalping film will scalp less than a comparable film comprising BAREX® in the sealant layer and/or layer adjacent to the sealant layer. In some embodiments, a minimally scalping film can scalp not more than about 1 to 90% of the polar cyclic compounds in a packaged product. Thus, in some embodiments, a minimally scalping film can scalp not more than about 1%, 2%, 3%, 4%, 5%,10%, 15%, 20%, 25%, 30%, 35%, 40%, 45%, 50%, 55%, 60%, 65%, 70%, 75%, 80%, 85%, or 90% of the polar cyclic compounds.

As used herein, the term “multilayer film” can refer to a thermoplastic film having one or more layers formed from polymeric or other materials that are bonded together by any conventional or suitable method, including one or more of the following methods: coextrusion, extrusion coating, lamination, vapor deposition coating, solvent coating, emulsion coating, or suspension coating.

The term “package” as used herein, can refer to a formed packaging material, filled or unfilled, closed or open, used for packaging a product.

As used herein, the term “phenol” can refer to a compound that includes a C₆H₅OH hydroxyl substituted aromatic ring. Phenols are aromatic alcohols can be optionally substituted with one or more substituents. Phenols can exhibit weak acidic properties and are sometimes called carbolic acids, especially in water solutions.

As used herein, the term “polymer” can refer to the product of a polymerization reaction, and can be inclusive of homopolymers, copolymers, terpolymers, and the like. In some embodiments, the layers of a film can consist essentially of a single polymer, or can have still additional polymers together therewith, i.e., blended therewith.

As used herein, the term “scalp” or “scalping” can refer to the phenomenon in which the concentration of a flavor, aroma, and the like in a product is reduced by the film used to package the product. The reduction in concentration can result from transport into or absorption by the film, by reaction of one or more film components with the flavor, aroma, etc., or by some other mechanism.

As used herein, the term “seal” can refer to any seal of a first region of a film surface to a second region of a film or substrate surface. In some embodiments, the seal can be formed by heating the regions to at least their respective seal initiation temperatures using a heated bar, hot air, infrared radiation, ultrasonic sealing, and the like. In some embodiments, the seal can be formed by an adhesive.

As used herein, the terms “seal layer”, “sealing layer”, “heat seal layer”, and/or “sealant layer”, can refer to an outer film layer involved in the sealing of the film to itself, another film, and/or another article that is not a film, and which becomes the innermost layer of the package formed from the film. With respect to packages having fin-type seals, the phrase “sealant layer” can refer to the inside film layer of a package, as well as supporting layers adjacent the sealant layer often being sealed to itself, and frequently serving as a food contact layer in the packaging of foods. In films having two seal layers, e.g., those used in constructing lap seal packages, the term “seal layer” as used herein can refer to that seal layer that is positioned on the interior of the package formed from the film.

As used herein, the term “semi-crystalline cyclic olefin copolymer” can refer to cyclic olefin copolymers that exist as liquids at temperatures above the melting point of the crystals, wherein some fraction of the copolymer remains uncrystallized, or amorphous, when cooled to room temperature.

As used herein, the term “skin layer” can refer to an outside layer of a multilayer film in packaging a product, the skin layer being subject to abuse.

As used herein, the term “tannin” can refer to tannic acid or gallotannic acid. Tannin can vary somewhat in composition, depending on the source, having the approximate empirical formula C₇₆H₅₂O₄₆. Tannic acid is a colorless to pale yellow solid believed to be a glucoside wherein each of the five hydroxyl groups of the glucose molecule is esterified with a molecule of digallic acid. In some embodiments, tannin can be used in tanning animal skins to make leather, manufacturing inks, as a mordant in dyeing, and in medicine as an astringent and for treatment of burns.

The term “terpenoid” as used herein can refer to terpenes and derivatives thereof having at least one C₅H₈ hydrocarbon unit with one or more points of unsaturation within the chemical structure. In some embodiments, the term “terpenoid” can refer to compounds and any molecules derived from the isoprenoid pathway, including 10, 15, and 20 carbon terpenoids and their derivatives, as well as carotenoids and xanthophylls.

As used herein, the term “tie layer” can refer to any internal layer having the primary purpose of adhering two layers to one another. In some embodiments, the tie layers can comprise any nonpolar polymer having a polar group grafted thereon, so that the polymer is capable of covalent bonding to polar polymers such as polyamide and ethylene/vinyl alcohol copolymer. In some embodiments, the tie layers can comprise, but are not limited to, modified polyolefin, modified ethylene/vinyl acetate copolymer, and/or homogeneous ethylene/alpha-olefin copolymer.

All compositional percentages used herein are presented on a “by weight” basis, unless designated otherwise.

### III. Cyclic Olefin Polymers and Copolymers

Cyclic olefin polymers are generally homopolymers that contain polymerized cyclic olefin units. Cyclic olefin polymers suitable with the presently disclosed subject matter can contain from about 0.1 to about 100 percent by weight polymerized cyclic olefin units; in some embodiments, from about 10 to about 99 by weight; in some embodiments, from about 50 to about 95 percent by weight, based on the total weight of the cyclic olefin polymer.

Cyclic olefin polymers are well known in the art. See, for example, U.S. Pat. No. 5,087,677, and references cited therein, which describes a process for preparing cyclic olefin polymers using a catalyst system that comprises a metallocene compound and an aluminoxane. Some other patents of interest in this regard include, for example, U.S. Pat. Nos. 5,422,409; 5,324,801; 5,331,057; 4,943,611; 5,304,596 and EP 608903. Cyclic olefin polymers suitable for use in the presently disclosed subject matter can include, but are not limited to, Zeonex® E48R, Zeonex® 480, Zeonex® 480R, Zeonex® RS820, and combinations thereof. One of ordinary skill in the packaging art would understand that one or more additional cyclic olefin polymers can be used in addition to or in place of the above-identified cyclic olefin polymers.

Cyclic olefin copolymers comprise a class of polymeric materials showing properties of high glass-transition temperature, optical clarity, low shrinkage, low moisture absorption, and low birefringence. There are several types of cyclic olefin copolymers based on different types of cyclic monomers and polymerization methods. Because of the bulky cyclic olefin units randomly or alternately attached to or in the polymer backbone, the copolymer becomes amorphous and shows the properties of high glass-transition temperature, Tg, optical clarity, low shrinkage, low moisture absorption, and low birefringence (Khanarian, G. (2001) Opt Engin. 40:1024-1029; Scheller. R. (1999) ETP'99 World Congress; Weller. T. (1999) ETP'99 World Congress).

Cyclic olefin copolymers are currently being produced by Mitsui Chemical Co. (Tokyo, Japan), Ticona Co. (Florence, Kentucky, United States of America), Japan Synthetic Rubber Co. (Yokkaichi, Japan) and Zeon Chemicals Co. (Louisville, Ky., United States of America). There are several types of commercial cyclic olefin copolymers based on different types of cyclic monomers and polymerization methods. In some embodiments, cyclic olefin copolymers can be produced by chain copolymerization of cyclic monomers with ethene, such as TOPAS® and Mitsui Chemical's APEL®, or by ring-opening metathesis polymerization of various cyclic monomers followed by hydrogenation (Japan Synthetic Rubber's ARTON®, Zeon Chemical's Zeonor®). Cyclic olefin copolymers suitable for use in the presently disclosed subject matter can include, but are not limited to, Zeonor® 1020R, Zeonor® 1060R, Zeonor® 1420R, Zeonor® 1600R, Topas® 8007, Topas® 6013, Topas® 5013, Topas® 6015, Topas® 6017, and combinations thereof. One of ordinary skill in the art would understand that one or more additional cyclic olefin copolymers can be used in addition to or in place of the above-identified cyclic olefin copolymers.

Semi-crystalline cyclic olefin copolymers are cyclic olefin copolymers that exist as liquids at temperatures above the melting point of the crystals. Some fraction of the copolymer remains uncrystallized, or amorphous, when cooled to room temperature. Particular semi-crystalline COCs suitable for use in the presently disclosed subject matter can include, but are not limited to, Topas® 8007, Topas® 6013, Topas® 5013, Topas® 6017, and combinations thereof.

Amorphous cyclic olefin copolymers are cyclic olefin copolymers having no long-range order of the components, or non-crystalline shape. Suitable amorphous COCs or cyclic olefin homopolymers can be selected from the group comprising Zeonor® 1020R, Zeonor® 1060R, Zeonor® 1420R, Zeonor® 1600R, Zeonor® E48R, Zeonor® 480, Zeonor® 480R, Zeonor® RS820, and combinations thereof.

It has now been surprisingly found that including cyclic olefin copolymers and/or cyclic olefin polymers in a packaging film minimally scalps polar cyclic compounds from the package contents. The presently disclosed subject matter includes packaging films that comprise a cyclic olefin copolymer and/or cyclic olefin polymer in the sealant layer and/or in the layer adjacent to the sealant layer. As a result, the presently disclosed subject matter advantageously provides a packaging. film containing cyclic olefin copolymer and/or cyclic olefin polymer in the sealant layer and/or the layer adjacent to the sealant layer to minimize scalping of polar cyclic compounds from the package contents.

### IV. Polar Cyclic Compounds

While there are many different classes of polar cyclic compounds, phenolics and terpenoids represent the largest class, as set forth in detail herein below. However, it is to be understood that the term “polar cyclic compound” as used herein refers to the entire class, and is not limited solely to phenolics and terpenoids.

### IV.A. Phenolics

Phenolics are a large and diverse group of aromatic compounds containing hydroxyl groups. Phenolics are found in plants, and can be characterized by the presence of more than one phenol group per molecule. Phenolics can be subdivided into hydrolyzable tannins, which are gallic acid esters of glucose and other sugars; and phenylpropanoids, such as lignins, flavonoids, and condensed tannins.

Although similar to alcohols, phenolics have unique properties and are not classified as alcohols (since the hydroxyl group is not bonded to a saturated carbon atom). They have relatively higher acidities due to a relatively loose bond between the oxygen and hydrogen. The acidity of the hydroxyl group in phenolics is commonly intermediate between that of aliphatic alcohols and carboxylic acids (pKₐ is usually between 10 and 12). Some phenolics are germicidal and can be used in formulating disinfectants.

The simplest of the class of phenolics is phenol. Phenol is a toxic, colorless crystalline solid with a sweet, tarry odor. Its chemical formula is C₆H₅OH and its structure is that of a hydroxyl group (—OH) bonded to a phenyl ring. Phenol has antiseptic and disinfectant properties, and is also the active ingredient in some oral anesthetics. In addition, phenol can also be used in the production of drugs (such as, for example, aspirin), weedkiller, and synthetic resins. Notwithstanding the hazardous effects of concentrated solutions, phenol can also be used as an exfoliant, to remove layers of dead skin and the like in personal care applications.

Tannins are another member of the phenolic class. Tannins are astringent, bitter-tasting plant polyphenols that bind and precipitate proteins. The term “tannin” refers to the use of tannins in tanning animal hides into leather; however, the term can be widely applied to any large polyphenolic compound containing sufficient hydroxyls and other suitable groups (such as carboxyls) to form strong complexes with proteins and other macromolecules. Tannins have molecular weights ranging from 500 to over 3,000. Tannins are commonly used in the process of tanning leather, as well as medicinally in anti-diarrheal, hemostatic, and antimicrobial compounds.

Lignins comprise an additional member of the phenolic class of compounds. Lignin is a complex chemical compound commonly derived from wood and comprises an integral part of the cell walls of plants. Lignin is a large, cross-linked, racemic macromolecule with a molecular mass in excess of 10,000μ and is relatively hydrophobic and aromatic in nature. Lignin has several unusual properties as a biopolymer, including its heterogeneity in lacking a defined primary structure. The degree of polymerization of lignin in nature is difficult to measure, since it is fragmented during extraction and consists of various types of substructures which appear to repeat in a haphazard manner.

Flavonoids make up an additional member of the phenolic class of compounds. The term “flavonoid” refers to a class of plant secondary metabolites. According to the IUPAC nomenclature, flavonoids can be classified into flavonoids (derived from 2-phenylchromen-4-one (2-phenyl-1,4-benzopyrone)), isoflavonoids (derived from 3-phenylchromen-4-one (3-phenyl-1,4-benzopyrone)), and neoflavonoids (derived from 4-phenylcoumarine (4-phenyl-1,2-benzopyrone)). Flavonoids are most commonly known for their antioxidant activity. Consumers and food manufacturers have become interested in flavonoids for their medicinal properties, especially their potential role in the prevention of cancers and cardiovascular disease. Particularly, the beneficial effects of fruit, vegetables, tea, and red wine have been attributed to flavonoid compounds.

An additional member of the phenolic class of compounds includes Triclosan. Triclosan (5-chloro-2-(2,4-dichlorophenoxy)phenol) is a potent wide spectrum antibacterial and antifungal agent. Triclosan occurs as a white powdered solid with a slight aromatic/phenolic odor. It is a chlorinated aromatic compound that has functional groups representative of both ethers and phenols. Triclosan is commonly found in soaps, deodorants, toothpastes, mouthwashes, and cleaning supplies, and is infused in an increasing number of consumer products, such as kitchen utensils, toys, bedding, socks, and trash bags. Triclosan has been shown to be effective in reducing and controlling bacterial contamination on the hands and on treated products.

### IV.B. Terpenoids (or Cyclic Terpenes)

The terpenoid family, sometimes referred to as “isoprenoids”, is a large and diverse class of naturally occurring organic chemicals, derived from five-carbon isoprene units assembled and modified in a wide variety of ways. Most terpenoids are multicyclic structures that differ from each another not only in functional groups, but also in the basic carbon skeleton. Terpenes are hydrocarbons resulting from the combination of several isoprene units. Particularly, terpenoids can be considered modified terpenes, wherein methyl groups have been moved or removed, or oxygen atoms added. Plant terpenoids are extensively used for their aromatic qualities. Particularly, they play a role in traditional herbal remedies and are under investigation for antibacterial, antineoplastic and other pharmaceutical effects. Terpenoids contribute to the scent of eucalyptus, the flavors of cinnamon, cloves and ginger.

Essential oils are commonly included in the class of terpenoids. An essential oil is any concentrated, hydrophobic liquid containing volatile aroma compounds. The term “essential” indicates that the oil carries distinctive scent (essence) of the plant, not that it is an especially important or fundamental substance. Essential oils do not require any specific chemical properties in common beyond conveying characteristic fragrances. Essential oils are generally extracted by distillation, expression, or solvent extraction, and are commonly used in perfumes and cosmetics, for flavoring food and drink, and for scenting incense and household cleaning products.

Anethole comprises an additional member of the terpenoid family. Anethole is an aromatic unsaturated ether compound that accounts for the distinctive “licorice” flavor of anise, fennel, star anise, and anise myrtle. It can also be referred to as p-propenylanisole, anise camphor, isoestragole, or oil of aniseed. The full chemical name of anethole is trans-1-methoxy-4-(prop-1-enyl)benzene.

Menthol is an additional member of the class of terpenoids. Menthol is a covalent organic compound made synthetically or obtained from peppermint or other mint oils. It is a waxy, crystalline substance, clear or white in color, and is a solid at room temperature. Menthol has local anesthetic and counterirritant qualities, and is widely used to relieve minor throat irritation, as well as an antipruritic to reduce itching, as a topical analgesic to relieve minor aches and pains, in decongestants, to treat sunburns, as an additive in certain cigarette brands, in mouthwash and toothpaste, in pesticides, and in perfumery, to name a few commercial applications.

Limonene is a non-polar hydrocarbon that can be included in the class of terpenes. Limonene is a colorless liquid at room temperature with an extremely strong smell of oranges. As the main odor constituent of citrus plant, Limonene is used in food manufacturing and some medicines, e.g., bitter alkaloids, as a flavoring, and added to cleaning products such as hand cleansers to give a lemon-orange fragrance.

### V. Presently Disclosed Films

### V.A. Sealant Layer

The presently disclosed film is a monolayer film or a multilayer film including at least one sealant layer. If the film is a monolayer film, then the sealant layer is the sole layer of the film, in which case the terms “film” and “layer” have the same meaning. If the film is multilayered, the sealant layer is an outer layer of the film; that is, having only one side directly adhered to another layer of the film, or to a substrate.

In some embodiments, the sealant layer can be coextruded with, or extrusion coated, extrusion laminated, or adhesive laminated, by means and methods well known in the art, to an adjacent film layer. The sealant layer, which can be disposed on one or both outer surfaces of the film structure, comprises cyclic olefin copolymer and/or cyclic olefin polymer, as set forth in detail above.

In some embodiments, the presently disclosed subject matter can comprise a packaging film comprising a sealant layer comprising at least 25 weight % cyclic olefin copolymer and/or at least 25 weight percent cyclic olefin polymer based on the total weight of the layer. In some embodiments, a layer adjacent to the sealant layer can comprise at least 25 weight % cyclic olefin copolymer and/or at least 25 weight percent cyclic olefin polymer based on the total weight of the layer. In some embodiments, both the sealant layer and the layer adjacent to the sealant layer comprise at least 25 weight % cyclic olefin copolymer and/or at least 25 weight percent cyclic olefin polymer based on the total weight of the layer. In some embodiments, the cyclic olefin copolymer can be selected from the group comprising semi-crystalline cyclic olefin copolymer, amorphous cyclic olefin copolymer, or combinations thereof. In some embodiments, the sealant layer and/or layer adjacent to the sealant layer can comprise not more than 75 weight % medium density polyethylene.

In some embodiments, the sealant layer and/or layer adjacent to the sealant layer can comprise about 25 to 100% cyclic olefin copolymer and/or cyclic olefin polymer; in some embodiments, from 60 to 90%; in some embodiments, from 70 to 80%. In some embodiments, the presently disclosed film can comprise a combination or blend of cyclic olefin copolymers and/or cyclic olefin polymers in the sealant layer and/or in the layer adjacent to the sealant layer. In some embodiments, the blend can comprise a ratio of about 50:50 cyclic olefin copolymer:cyclic olefin polymer; in some embodiments, about 10:90, 20:80, 30:70, 40:60, 60:40, 70:30, 80:20, and 90:10.

Accordingly, the presently disclosed subject matter comprises a film structure having a seal layer and/or layer adjacent to the seal layer wherein an effective amount of cyclic olefin copolymer and/or cyclic olefin polymer has been added. As used herein, the term “effective amount” can be defined as an amount of cyclic olefin polymer and/or cyclic olefin copolymer that achieves a reduction in the scalping of polar cyclic compounds while maintaining good heat sealing and/or other desirable properties.

Thus, the presently disclosed films exhibit decreased scalping of polar cyclic compounds contained in products packaged by the disclosed films. Particularly, in some embodiments, the disclosed films exhibit decreased scalping of polar cyclic compounds of not more than about 1% to about 90%. In some embodiments, the presently disclosed films exhibit decreased scalping of polar cyclic compounds compared to comparable films comprising BAREX® in the sealant layer and/or layer adjacent to the sealant layer. In some embodiments, the presently disclosed films exhibit decreased scalping of polar cyclic compounds compared to films that lack cyclic olefin copolymer and/or cyclic olefin polymers in the sealant layer and/or layer adjacent to the sealant layer.

### V.B. Barrier Layers

In some embodiments, the presently disclosed film can comprise one or more oxygen barrier layers that can be made from materials having an oxygen permeability of less than about 500 cm³ O₂/m² day•atmosphere (tested at 1 mil thick and at 25° C. according to ASTM D3985), such as in some embodiments less than about 100, in some embodiments less than about 50, in some embodiments less than about 25, in some embodiments less than about 10, in some embodiments less than about 5, and in some embodiments less than about 1 cm³ O₂/m² day•atmosphere.

In some embodiments, barrier layers can comprise, but are not limited to, oriented PET, polyvinylidene chloride (PVDC), ethylene vinyl alcohol (EVOH), nylon and/or biaxially oriented nylon, polyacrylonitrile, vinylidene chloride/methyl acrylate copolymer, polyamide, metallized and/or silicon oxide-coated polymers, and polyester blends or composites of the same as well as related copolymers thereof. In some applications, the functions of structure and barrier layers can be combined in a single layer of a suitable resin. For example, in some embodiments nylon and/or PET can be suitable for both structure and barrier functions.

In some embodiments, one or more layer of the presently disclosed film can comprise (in addition to or independent of the oxygen barrier layer) an oxygen scavenger. As would be readily apparent to one of ordinary skill in the art, an oxygen scavenging material is a composition, compound, continuous or discontinuous film layer, coating, or the like, that can consume, deplete, and/or react with oxygen from a given environment. Any of a wide variety of oxygen scavengers can be used in the presently disclosed subject matter, as would be apparent to one of ordinary skill in the art.

In some embodiments, the presently disclosed film can comprise one or more moisture barrier layers to minimize wetting of the film. In some embodiments, the moisture barrier material can include, but is not limited to, polyolefins (e.g. polyethylene), PET, polyacrylonitrile copolymer, polyamides, ethylene vinyl alcohol copolymers, ethylene vinyl acetate copolymers, polyesters grafted with maleic anhydride, PVdC, aliphatic polyketones and liquid crystalline polymers, nanosize particles of a modified clay, propylene polymers or copolymers, hydrocarbons, and/or combinations thereof.

In some embodiments, the presently disclosed film can comprise one or more UV (ultraviolet) barrier layers. Many packaging applications have a need for a transparent UV barrier film. Such packaging material can be used for foods, medicines, medical devices, and/or cosmetics and can increase the shelf life and reduce other measures to preserve the material packaged. Such UV barrier materials can include, but are not limited to, substituted and/or nonsubstituted benzotriazole derivatives, benzotriazine derivatives, hindered amines, hydroxybenzophenone derivatives, poly(ethylene naphthalate), and/or combinations thereof.

In some embodiments, commonly used color pigments or dyes can be added to any of the layers of the presently disclosed film to extend the UV/visible wavelength blockage to a higher wavelength, i.e., in some embodiments to about 480-500 nm. Such color pigments or dyes can include, but are not limited to, metal oxides, e.g., titanium oxide, carbon black, and oxidic colored pigments, azo compounds (monoazo, diazo, salts of azo color acids, etc.), non-azo pigments (polycyclic structure, such as phthalocyanine, quinacridones, perylene, naphthalene tetracarboxylic acid derivatives, etc.), fluorescent pigments (naphthazine, etc.), organic dyes (anthraquinone, quinophthalone, pyrazolone, xanthene, azine, etc.), and the like.

In some embodiments, various metal foils can be used as one or more barrier layers or outside layers in the presently disclosed films. Examples of such metal foil layer can include, but are not limited to, surface-treated steel foil, surface-treated iron foil, and light metal foils, such as aluminum. Examples of the surface-treated steel foil can include various steel foils subjected to one or more surface treatments, such as zinc plating, tin plating, nickel plating, electrolytic chromic acid treatment, phosphoric acid treatment, and chromic acid treatment. Examples of the light metal foil can include, but are not limited to, pure aluminum and aluminum alloy. In some embodiments, the metal foil can have a thickness of about 3 to 100 μm.

### V.C. Abuse Layer

In some embodiments, the presently disclosed film can comprise one or more structural or abuse layers that can serve to resist abrasion, puncture, and/or other potential causes of reduction of package integrity, as well as potential causes of reduction of package appearance quality. In some embodiments, the abuse layer can comprise, but is not limited to, oriented polyester (such as oriented polyethylene terephthalate), oriented polypropylene, oriented polyamide (nylon) and/or combinations thereof.

In some embodiments, the abuse layer can be reverse-printable and unaffected by the sealing temperatures used to make the presently disclosed package and compartments. In some embodiments, the abuse layer can be provided with graphic elements such as printing and embossing to provide information for the consumer and/or a pleasing appearance to the package. In some embodiments, the package can be sealed through the entire thickness of the multilayer structure. The thickness of the abuse layer can be selected to control the stiffness of the film, and in some embodiments can range from about 10 μm to about 90 μm, in some embodiments from about 10 μm to about 60 μm, and in some embodiments about 50 μm.

### V.D. Tie Layers

In some embodiments, the presently disclosed film can comprise one or more tie layers to adhere two film layers, to adhere a film to another material, or to enhance the adhesion between two layers in a co-extruded substrate. In some embodiments, the tie layer can comprise any suitable polymeric adhesive that functions to bond two layers together. In some embodiments, tie layers can comprise any polymer having a polar group grafted thereon, such that the polymer is capable of bonding to polar polymers, including polyamide, ethylene/vinyl alcohol copolymer and/or combinations thereof.

Accordingly, materials that can comprise one or more tie layers in the presently disclosed subject matter can include, but are not limited to, ethylene/vinyl acetate copolymer; anhydride grafted ethylene/vinyl acetate copolymer; ethylene/unsaturated acid copolymer; ethylene/unsaturated ester copolymer; anhydride grafted ethylene/alpha olefin copolymer; anhydride grafted polypropylene; anhydride grafted low density polyethylene; ethylene/methyl acrylate copolymer, anhydride grafted high density polyethylene; ionomer resin; ethylene/acrylic acid copolymer; anhydride-grafted ethylene/alpha-olefin interpolymer; anhydride-grafted ethylene/ethylenically unsaturated ester interpolymer; and anhydride-grafted ethylene/ethylenically unsaturated acid; interpolymer ethylene/methacrylic acid copolymer; anhydride grafted ethylene/methyl acrylate copolymer; polymers that contain mer units derived from at least one of C₂-C1₂ alpha-olefin, styrene, amide, or ester, and/or combinations thereof.

In some embodiments, adhesive layers can be employed to laminate the presently disclosed films to metallized foil and/or a desired substrate according to well known processes known to those skilled in the art. In some embodiments, such adhesive layers can include, but are not limited to, ethylene acrylic acid, ethylene methacrylic acid, and combinations thereof.

### V.E. Additives

In some embodiments of the presently disclosed subject matter, one or more conventional packaging film additives can be included. Examples of additives that can be incorporated in the presently disclosed films can include, but are not limited to, antiblocking agents, antistats, antioxidants, dyes, pigments, antifogging agents, plasticizers, stabilizers, slip agents, colorants, flavorants, fillers, antimicrobial agents, scents, processing agents, fire retardants, UV absorbers, meat preservatives, corrosion inhibitors, UV stabilizers, and combinations thereof. For example, one or more antiblocking agents (such as corn starch and/or ceramic microspheres) can be included in and/or on one or both outer layers of the film structure when the film is to be processed at high speeds.

### V.F. Film Layers

The films of the presently disclosed subject matter can have any number of layers desired, so long as the film provides the desired properties for the particular packaging operation in which the film is used. The outer layer can function as a sealing layer, while the core layer, or at least one of a plurality of inner layers, can provide the film with one or more desired properties, and can permit a desired level of gaseous transmission therethrough. Thus, in some embodiments the film can comprise a total of from 1 to 20 layers; in some embodiments, from 1 to 12 layers; in some embodiments, from 1 to 9 layers, and in some embodiments, from 3 to 8 layers. Thus, in some embodiments, the multilayer film can comprise 1, 2, 3, 4, 5, 6, 7, 8, 9, 10, 11, or 12 layers.

### V.G. Film Thickness

The presently disclosed film can have any total thickness desired, so long as the film provides the desired properties, e.g. elastic recovery, abuse resistance, tensile strength, shrink force, rigidity, optics, modulus, seal strength, and/or the like, for the particular packaging operation in which the film is used. Thus, in some embodiments, the film can have a total thickness (i.e., a combined thickness of all layers) of from about 0.5 to about 15 mils (1 mil equals 0.001 inch); in some embodiments, from about 1 to about 10 mils; in some embodiments, from about 1 to about 3 mils; in some embodiments, from about 1 to about 2.5 mils.

### VI. Film Substrate

Although the presently disclosed films can be sealed to themselves to form a sealed package (for example, as in the VFFS or HFFS packaging methods known in the art), in some embodiments, the film can be sealed to a substrate in one or more selected areas (e.g., perimeter area) to form a sealed package. In some embodiments, the substrate can be flexible or rigid. In some embodiments, the substrate can be a monolayer substrate film or a multilayer substrate film, such as those thermoplastic films used as the formed web (e.g., “bottom” web) of the thermoforming or vacuum skin packaging methods known in the art. In some embodiments, the substrate can include a flexible or rigid metal (e.g., aluminum foil) or cellulosic (e.g., paper) flexible substrate.

In some embodiments, the substrate can comprise a monolayered or multilayered rigid support, such as a plastic or corrugated backing board having a surface film layer, coating or other modification to facilitate sealing to the film, or rigid tray having perimeter flange with a similar film layer, coating or modification at least in the flange area to facilitate sealing to the film. The rigid trays or supports can be formed from thermoset plastics, thermoplastics (e.g., expanded polystyrene sheet material which has been thermoformed into a desired shape), cellular or foamed plastics (e.g., extruded polystyrene foam sheet), metal, and/or combinations thereof.

### VII. Manufacture of the Film

The film of the presently disclosed subject matter can be manufactured by any of a variety of thermoplastic film-forming processes known in the art (e.g., tubular or blown-film extrusion, coextrusion, extrusion coating, flat or cast film extrusion, and the like). A combination of these processes can also be employed.

The presently disclosed film can be oriented or non-oriented. In some embodiments, the film can be oriented in either the machine (i.e., longitudinal), transverse direction, or both directions (i.e., biaxially oriented), for example, in order to enhance the optics, strength, or durability of the film. For example, the film can be oriented in one of the machine or transverse directions or in both of these directions by at least about any of the following ratios: 2:1, 2.5:1, 2.7:1, 3:1, 3.5:1, and 4:1. In some embodiments, the film can be oriented in one of the machine or transverse directions or in both of these directions by no more than about any of the following ratios: 10:1, 9:1, 8:1, 7:1, 6:1, 5:1, and 4:1. If the film is oriented, then it can be heat set or annealed after orientation to reduce the heat shrink attribute to a desired level or to help obtain a desired crystalline state of the film.

### VIII. Methods of Using the Film

The presently disclosed film can be used in packaging a wide variety of articles or objects, such as for example, food, beverages, medications, biocides, and personal care items. To form the packaged article, the disclosed film can be heat sealed to another film, to itself (for example, by a fin seal and/or a lap seal arrangement), or to a substrate (such as, for example, metal foil) to form an open package such as a bag, pouch (e.g., vertical or horizontal form-fill-sealed pouch), tube, or other containment configuration into which an article is placed before the package is sealed. In some embodiments, heat sealing can occur by one or more of thermal conductance heat sealing, impulse sealing, ultrasonic sealing, dielectric sealing, and the like.

Thus, in some embodiments, the presently disclosed subject matter can comprise a method of minimally scalping polar cyclic compounds from a packaged product. The method can comprise packaging a product in a packaging film comprising a sealant layer (and/or a layer adjacent to the sealant layer) comprising cyclic olefin copolymer and/or cyclic olefin polymer. In some embodiments, the cyclic olefin copolymer comprises semi-crystalline cyclic olefin copolymer, amorphous cyclic olefin copolymer and/or combinations thereof. In some embodiments, the sealant layer and/or layer adjacent to sealant layer comprises at least 25 weight % cyclic olefin copolymer and/or cyclic olefin polymer based on the total weight of the layer. In some embodiments, the sealant layer and/or layer adjacent to the sealant layer can comprise at least 25, 30, 35, 40, 45, 50, 55, 60, 65, 70, 75, 80, 85, 90, 95, or 100 weight % cyclic olefin copolymer and/or cyclic olefin polymer based on the total weight of the layer. In some embodiments, the film scalps not more than about 1 to 90% of the polar cyclic compounds contained in the packaged product and/or in contact with the film. Thus, in some embodiments, the presently disclosed film scalps not more than about 1%, 2%, 3%, 4%, 5%, 10%, 15%, 20%, 25%, 30%, 35%, 40%, 45%, 50%, 55%, 60%, 65%, 70%, 75%, 80%, 85%, or 90% of the polar cyclic compounds.

In some embodiments, the film can be heat sealed to a support member, such as a thermoformed tray having a central depressed area and a surrounding peripheral flange. The packaged product can first be placed on the tray. The film can then be positioned over the packaged product and heat sealed to the peripheral flange of the tray to hermetically enclose the packaged product and form a container enclosing the packaged product. In such arrangement, the film is the “lid” or “lidstock” and the tray is a “support member.”

The exact requirements of a container or pouch made from the disclosed film can depend on a variety of factors, including but not limited to, the chemical nature of the packaged product, amount of the packaged product, concentration of aroma, etc. in the packaged product, physical configuration of the packaged product, presence of hermetic sealing, vacuumization and/or modified atmosphere inside the container, initial oxygen concentration inside the container, intended end use of the packaged product, intended storage time of the container before use, and the like.

### IX. Packaged Products

In some embodiments, the presently disclosed subject matter can comprise a packaged product comprising the disclosed film surrounding a product. The disclosed film comprises a sealant layer (and/or layer adjacent to the sealant layer) comprising cyclic olefin copolymer and/or cyclic olefin polymer. In some embodiments, the sealant layer and/or layer adjacent to the sealant layer comprises at least 25 weight % cyclic olefin copolymer and/or 25 weight % cyclic olefin polymer based on the total weight of the layer. In some embodiments, the sealant layer and/or layer adjacent to the sealant layer can comprise at least 25, 30, 35, 40 45, 50, 55, 60, 65, 70, 75, 80, 85, 90, 95, or 100 weight % cyclic olefin copolymer or cyclic olefin polymer based on the total weight of the layer. In some embodiments, the film scalps not more than about 1 to 90% of the polar cyclic compounds in the packaged product. Thus, in some embodiments, the presently disclosed film scalps not more than about 1%, 2%, 3%, 4%, 5%, 10%, 15%, 20%, 25%, 30%, 35%, 40%, 45%, 50%, 55%, 60%, 65%, 70%, 75%, 80%, 85%, or 90% of the polar cyclic compounds.

In general, the presently disclosed film can have a wide variety of applications in the packaging art, such as for example, packaging liquids, creams, salves, lotions, solutions, and like media that are edible and/or used in medicinal applications, personal care products, cleaning products, and/or a wide variety of other applications.

Continuing, edible applications can include, but are not limited to, breath fresheners, candies, coffee and other food or beverage extracts, essential oils, flavorings, foods, beverages, condiments, seasonings, herbal extracts, and the like.

Medicinal applications can include, but are not limited to, eye drops, eye lubricants, decongestants, medications, ointments, mineral solutions, vitamins, cough drops, cold medications, antibiotic ointments and creams, cold and hot packs, wipes, swabs, bandages, liquid bandages, nasal sprays and drops, lozenges, astringents, toners, and the like.

Personal care applications can include, but are not limited to, body oils, body washes, colognes, petroleum jellies, shampoos, conditioners, deodorants, fabric conditioners, fabric softeners, fragrances, hair treatments, lip balms, lotions, colorants, hairdressings, hand soaps, moisturizers, mouthwashes, perfumes, salts, deodorants, sunscreen, soap, shaving cream, body powder, makeup, hairspray, bubble bath, aftershave, and the like.

Cleaning applications can include, but are not limited to, oils, floor cleaners, carpet cleaners, furniture cleaners, appliance cleaners, disinfectants, glass cleaners, detergents, pastes, polishes, stain removers, allergen removers, sanitizing systems, and the like.

Other applications can include, but are not limited to, fertilizers, fuel treatments, rust inhibitors, insect repellants, liniments, emulsions, gels, greases, paints, and the like.

One of ordinary skill in the art would appreciate that the above list is not exhaustive, and the presently disclosed film and methods can be used in packaging applications not listed hereinabove.

### EXAMPLES

The following Examples provide illustrative embodiments of the presently disclosed subject matter. In light of the present disclosure and the general level of skill in the art, those of ordinary skill can appreciate that the following Examples are intended to be exemplary only and that numerous changes, modifications, and alterations can be employed without departing from the scope of the presently disclosed subject matter.

Tables 1 and 2 below list resin identification and multilayer film construction information, as follows:

TABLE I
Resin Identification

| Sample | ID | Description |
|---|---|---|
| A | Petrothene ® NA | Equistar Chemicals (Houston, Texas, |
| | 345-013 | United States of America) |
| B | BAREX ® 210 | INEOS BAREX, Delaware City, |
| | | Delaware, United States of America. |
| C | PRIMACOR 1321 | Dow Chemical Company (Midland, |
| | | Michigan, United States of America) |
| D | PLA 4042D | NatureWorks, LLC (Minnetonka, |
| | | Minnesota, United States of America) |
| E | Topas ® 8007 F- | Topas Advanced Polymers, Inc. |
| | 04 | (Florence, Kentucky, United States |
| | | of America) |
| F | ULTRAMID ® C33 | BASF Corporation (Florham Park, New |
| | 01 | Jersey, United States of America) |
| G | FORTIFLEX ® | Ineos Films (Schlossmattenstr, |
| | T60-500-119 | Bötzingen, Germany) |
| H | PRIMACOR ® | Dow Chemical Company (Midland, |
| | 1410 | Michigan, United States of America) |
| I | Grivory G21 | EMS-Chemie (North America), Inc. |
| | Natural | (Sumter, South Carolina, United |
| | | States of America) |
| J | DOWLEX ® 2037 | Dow Chemical Company (Midland, |
| | | Michigan, United States of America) |
| K | TOPAS ® 9506X1 | Topas Advanced Polymers, Inc. |
| | | (Florence, Kentucky, United States |
| | | of America) |
| L | DS101.01 | Dow Chemical Company (Midland, |
| | | Michigan, United States of America) |
| M | TOPAS ® 6013 | Topas Advanced Polymers, Inc. |
| | | (Florence, Kentucky, United States |
| | | of America) |
| N | ZEONOR ® | Nippon Zeon Corporation (Tokyo, |
| | 1020R | Japan) |
| O | ZEONOR ® | Nippon Zeon Corporation (Tokyo, |
| | 1600R | Japan) |
| P | TOPAS ® 6017 | Topas Advanced Polymers, Inc. |
| | | (Florence, Kentucky, United States |
| | | of America) |
| Q | TOPAS ® 6015 | Topas Advanced Polymers, Inc. |
| | | (Florence, Kentucky, United States |
| | | of America) |

A is a low density polyethylene (LDPE) homopolymer, having a density of 0.918-0.924 g/cc at 23° C. and a melting point (DSC) of 112° C.
B is an impact modified acrylonitrile-methylacrylate copolymer barrier resin having a specific gravity of about 1.5.
C is an ethylene/acrylic acid copolymer (“EAA”) with less than 10 weight percent acrylic acid content.
D is a polyester having density of about 1.25 g/cc (according to ASTM D1928), melting point of about 140-152° C. (according to ASTM D1003), and glass transition point of about 56.7-57.9° C. (according to ASTM D3418).
E is a semi-crystalline cyclic olefin copolymer (“COC”) (ethylene/norbornene copolymer) having antioxidant content of about 150-200 ppm Irganox 1010, and glass transition temperature of about 85° C.
F is a polyamide (nylon), specifically Nylon 6/66 (Poly (caprolactam/hexamethylenediamine/adipic acid) with melting point (DSC) of 190-202° C. and density of about 1.10-1.16 g/cc.
G is a high density polyethylene homopolymer having flow rate of 4.5-7.5 grams/10 minutes, density of 0.961 g/cc at 23° C., and vicat softening point of 133° C.
H is an ethylene/acrylic acid copolymer, with less than 10% acrylic acid content having flow rate of 1.0-2.0 g/10 minutes (Condition E), density of 0.938 g/cc at 23° C., and 9.5% acrylic acid content.
I is an amorphous polyamide nylon copolymer (6I/6T) comprised of hexamethylene diamine, isophthalic acid and terephthalic acid, with density of 1.16-1.20 g/cc and glass transition temperature of 257° F.
J is a medium density polyethylene (“MDPE”) having melting point of about 124.7° C., and density of about 0.932-0.937 g/cc.
K is a semi-crystalline cyclic olefin copolymer (ethylene/norbornene copolymer) with density of 0.974 g/cc and glass transition temperature of from about 30-36° C.
L is a styrene/ethylene copolymer containing 74-77 wt % styrene, density of about 1.02 g/cc, and glass transition temperature of about 28° C.
M is a semi-crystalline cyclic olefin copolymer (ethylene/norbornene copolymer) with glass transition temperature of 140° C.
N is an amorphous cyclic olefin copolymer with a melt flow of 11-17 g/10 minutes, Tg of 212° F., and a refractive index of 1.53.
O is an amorphous cyclic olefin copolymer having a glass transition temperature of about 105° C.
P is a semi-crystalline cyclic olefin copolymer (ethylene/norbornene copolymer) having glass transition temperature of about 180° C.
Q is a semi-crystalline cyclic olefin copolymer (ethylene/norbornene copolymer).

The film formulations used in the Examples were prepared according to Table 2.

### Table 2

Film Formulations

| Film ID | | Layer 1 | Layer 2 | Layer 3 | Total |
|---|---|---|---|---|---|
| Film 1 | Formulation | A | — | — | — |
| | Volume % | 100 | — | — | 100 |
| | Micron | 90 | — | — | 90 |
| Film 2 | Formulation | B | — | — | — |
| | Volume % | 100 | — | — | 100 |
| | Micron | 90 | — | — | 90 |
| Film 3 | Formulation | C | — | — | — |
| | Volume % | 100 | — | — | 100 |
| | Micron | 90 | — | — | 90 |
| Film 4 | Formulation | D | — | — | — |
| | Volume % | 100 | — | — | 100 |
| | Micron | 90 | — | — | 90 |
| Film 5 | Formulation | E | — | — | — |
| | Volume % | 100 | — | — | 100 |
| | Micron | 90 | — | — | 90 |
| Film 6 | Formulation | F | — | — | — |
| | Volume % | 100 | — | — | 100 |
| | Micron | 90 | — | — | 90 |
| Film 7 | Formulation | E/A | — | — | — |
| | Volume % | 50/50 | — | — | 100 |
| | Micron | 90 | — | — | 90 |
| Film 8 | Formulation | E/C | — | — | — |
| | Volume % | 50/50 | — | — | 100 |
| | Micron | 90 | — | — | 90 |
| Film 9 | Formulation | G | — | — | — |
| | Volume % | 100 | — | — | 100 |
| | Micron | 90 | — | — | 90 |
| Film 10 | Formulation | H | — | — | — |
| | Volume % | 100 | — | — | 100 |
| | Micron | 90 | — | — | 90 |
| Film 11 | Formulation | I | — | — | — |
| | Volume % | 100 | — | — | 100 |
| | Micron | 90 | — | — | 90 |
| Film 12 | Formulation | G/E | — | — | — |
| | Volume % | 50/50 | — | — | 100 |
| | Micron | 90 | — | — | 90 |
| Film 13 | Formulation | J/E | — | — | — |
| | Volume % | 50/50 | — | — | 100 |
| | Micron | 90 | — | — | 90 |
| Film 14 | Formulation | J | — | — | — |
| | Volume % | 100 | — | — | 100 |
| | Micron | 90 | — | — | 90 |
| Film 15 | Formulation | K | — | — | — |
| | Volume % | 100 | — | — | 100 |
| | Micron | 90 | — | — | 90 |
| Film 16 | Formulation | L | — | — | — |
| | Volume % | 100 | — | — | 100 |
| | Micron | 90 | — | — | 90 |
| Film 17 | Formulation | M | — | — | — |
| | Volume % | 100 | — | — | 100 |
| | Micron | 90 | — | — | 90 |
| Film 18 | Formulation | N | — | — | — |
| | Volume % | 100 | — | — | 100 |
| | Micron | 90 | — | — | 90 |
| Film 19 | Formulation | O | — | — | — |
| | Volume % | 100 | — | — | 100 |
| | Micron | 90 | — | — | 90 |
| Film 20 | Formulation | J | C | — | — |
| | Volume % | 67.0 | 33.0 | — | 100.0 |
| | Micron | 60.3 | 29.7 | — | 90.0 |
| Film 21 | Formulation | J | 90% E | C | — |
| | | | 10% J | | |
| | Volume % | 30.0 | 60.0 | 10.0 | 100 |
| | Micron | 27.0 | 54.0 | 9.0 | 90 |
| Film 22 | Formulation | J | 50% E | C | — |
| | | | 50% J | | |
| | Volume % | 30.0 | 60.0 | 10.0 | 100 |
| | Micron | 27.0 | 54.0 | 9.0 | 90 |
| Film 23 | Formulation | J | 50% M | C | — |
| | | | 50% J | | |
| | Volume % | 30.0 | 60.0 | 10.0 | 100 |
| | Micron | 27.0 | 54.0 | 9.0 | 90 |
| Film 24 | Formulation | J | 50% P | C | — |
| | | | 50% J | | |
| | Volume % | 30.0 | 60.0 | 10.0 | 100 |
| | Micron | 27.0 | 54.0 | 9.0 | 90 |
| Film 26 | Formulation | J | C | — | — |
| | Volume % | 90.0 | 10.0 | — | 100 |
| | Micron | 81.0 | 9.0 | — | 90 |
| Film 27 | Formulation | J | 50% Q | C | — |
| | | | 50% J | | |
| | Volume % | 30.0 | 60.0 | 10.0 | 100 |
| | Micron | 27.0 | 54.0 | 9.0 | 90 |
| Film 28 | Formulation | J | 75% M | C | — |
| | | | 25% J | | |
| | Volume % | 30 | 60.0 | 10.0 | 100 |
| | Micron | 27 | 54.0 | 9.0 | 90 |
| Film 29 | Formulation | J | 75% P | C | — |
| | | | 25% J | | |
| | Volume % | 30.0 | 60.0 | 10.0 | 100 |
| | Micron | 27.0 | 54.0 | 9.0 | 90 |
| Film 30 | Formulation | J | 75% Q | C | — |
| | | | 25% J | | |
| | Volume % | 30.0 | 60.0 | 10.0 | 100 |
| | Micron | 27.0 | 54.0 | 9.0 | 90 |
| Film 31 | Formulation | J | M | C | — |
| | Volume % | 30.0 | 60.0 | 10.0 | 100 |
| | Micron | 27.0 | 54.0 | 9.0 | 90 |
| Film 32 | Formulation | J | P | C | — |
| | Volume % | 30.0 | 60.0 | 10.0 | 100 |
| | Micron | 27.0 | 54.0 | 9.0 | 90 |
| Film 33 | Formulation | J | Q | C | — |
| | Volume % | 30.0 | 60.0 | 10.0 | 100 |
| | Micron | 27.0 | 54.0 | 9.0 | 90 |
| Film 34 | Formulation | J/E | — | — | — |
| | Volume % | 75/25 | — | — | 100 |
| | Micron | 90 | — | — | 90 |
| Film 35 | Formulation | J/E | — | — | — |
| | Volume % | 25/75 | — | — | 100 |
| | Micron | 90 | — | — | 90 |

### Methods and Materials

### A. Materials and Standards

Triclosan, also known as Irgasan DP300 or 5-chloro-2-(2,4-dichlorophenoxy)phenol, was obtained from Ciba Specialty Chemicals (Tarrytown, N.Y., United States of America). Anethole (1-methoxy-4-(1-propenyl benzene) was obtained from ChemService (Westchester, Pa., United States of America). Menthol (2-(2-propyl)-5-methylcyclohexanol), BHT (2,6-bis(1,1-dimethylethyl)-4-methylphenol), Limonene, and methylene chloride were obtained from Sigma-Aldrich (Milwaukee, Wis., United States of America).

Acetonitrile was obtained from Thermo-Fisher Scientific (Pittsburgh, Pa., United States of America). Ethanol was obtained from AAPER Alcohol & Chemical Co. (Shelbyville, Ky., United States of America). Water was obtained from an in-house deiononization/filtration system.

### B. Instrumentation

Purity verification of standards, and quantification of target analytes in accelerated time studies was accomplished via liquid chromatography mass spectrometry (LC/MS) using an Agilent 1100 Series LC/MS System (available from Agilent Technologies, Foster City, Calif., United States of America). The system consisted of an 1100 binary HPLC pump coupled with a diode array detector (DAD) and a single quadruple mass spectrometer with an atmospheric pressure chemical ionization source (APCI). A Phenomenex Luna 50 mm×2.0 5 μm C8 column was used for the separation (available from Phenomenex, Inc., Torrance, Calif., United States of America).

Analysis of film extracts after exposure to toothpaste was accomplished via gas chromatography (GC) using an HP-5890 Series II GC (available from Agilent Technologies, Foster City, Calif., United States of America.) The GC system was equipped with a 50 μL tapered syringe, a cool on-column injector, a flame ionization detector, and an HP 7673 Auto Injector. The GC column used was an RTx-1, 60 m×0.53 mm i.d., 0.5 μm film thickness (available from Restek Chromatography Products, Bellefonte, Pa., United States of America).

### C. Triclosan Scalping Test—10% Ethanol

A standard solution was prepared by dissolving Triclosan in 10% ethanol at a concentration of about 10 μg/mL. While the 10% ethanol concentration was believed to be lower than concentrations found in many personal care items, such as toothpaste, the low concentration was needed to visualize measurable decreases in Triclosan after exposure to the test films during accelerated time studies. In addition, Triclosan is only sparingly soluble in 10% ethanol, and higher concentrations would increase the risk of solution saturation, which could introduce significant errors.

Experiments were carried out directly in 6 mL LC autosampler vials. In each case, the films were cut into 1″×5″ strips, curled up, and added to the autosampler vials of the Agilent 1100 LC/MS System described in Section B. Film thickness was targeted to be 90 microns for all samples. The vials were then filled with about 5 mL of the 10 μg/mL Triclosan solution and incubated at room temperature in the autosampler during the time study. By doing so, measuring the decrease in Triclosan concentration over time could be fully automated.

An isocratic mobile phase of 50:50 acetonitrile:water was used at a flow rate of 1 mL/min with a 5 μL sample injection volume. Using these conditions, Triclosan eluted at 1.6 minutes and was detected using UV at a wavelength of 230 nm and negative APCI at a nominal m/z of 287, corresponding to the deprotonated molecular ion ([M−H]⁻). The total run time was 2.5 minutes, which allowed many samples to be analyzed concurrently.

### D. Anethole Scalping Test—30% Ethanol

Measurement of the scalping of Anethole from ethanol solutions was accomplished as described in Section C with two exceptions. First, because Anethole was insoluble in 10% ethanol, a standard solution of Anethole was prepared using 30% ethanol. Second, the analytical method was modified as follows: Anethole retention time was 0.9 minutes and was detected using UV at a wavelength of 210 nm and positive APCI at a nominal m/z of 149, corresponding to the protonated molecular ion ([M+H]⁺).

### E. BHT Scalping Test—30% Ethanol

Measurement of the scalping of BHT from ethanol solutions was accomplished as described in Section C with two exceptions. First, because BHT was insoluble in 10% ethanol, a standard solution of BHT was made in 30% ethanol. Second, the analytical method was modified as follows: isocratic 65:35 acetonitrile:water with UV detection at a wavelength of 210 nm and positive APCI at a nominal m/z of 219. Retention time of BHT under these conditions was 1.2 minutes.

F. Scalping of Triclosan and Flavor Components from Toothpaste

After the initial extraction of pouches from the test structures in toothpaste, the toothpaste was removed and the pouches washed with water. 1″×5″ strips were removed from the washed pouches and extracted overnight in 15mL of methylene chloride at 40° C. Extracts were then filtered and analyzed for Limonene, Menthol, Anethole and Triclosan using on-column gas chromatography. External standards of each analyte were prepared in the operating range of the samples. A first order calibration curve was calculated using peak area resulting in an r² typically >0.9990 for each analyte. Details of the chromatographic conditions are listed below in Table 3.

TABLE 3
Experimental Chromatographic Conditions

| | |
|---|---|
| Instrument | HP-5890 Series II GC with cool on-column |
| | injector with Flame Ionization Detector |
| | and HP 7673 Auto Injector with a 50 uL |
| | tapered syringe |
| Column | RTx-1 , 60 m × 0.53 mm i.d., 0.5 um |
| | film thickness |
| Oven Program | 140° C. for 2 min., then 25° C./min. |
| | to 275° C., hold for 7.6 min. |
| Injection Volume | 0.5 uL |
| Electronic Pressure | Helium carrier gas with flow pressure |
| Control | programmed at a constant rate based on |
| | 13.2 psi at 140° C. Flow = 5.5 mL/min |
| Injector Temperature | 250° C. |
| Detector Temperature | 300° C. |
| Retention Time, | Limonene: 2.75 |
| minutes | Menthol: 3.34 |
| | Anethole: 3.88 |
| | Triclosan: 7.95 |

Films were extracted for an additional 24 hours to verify completeness of the extraction and the results were added to the day one results.

### Example 1

### 14-Day Monolayer Film Time Study of Triclosan Scalping

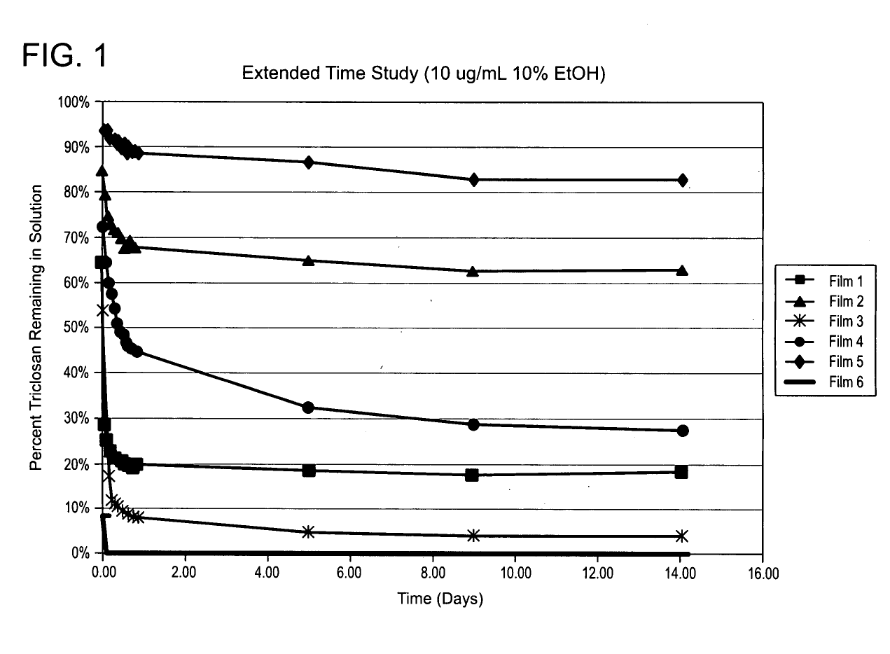

An approximately 10 μg/mL solution of Triclosan was prepared by dissolving Triclosan in 10% ethanol. The solution was then exposed to a plurality of monolayer films to be tested for scalping, and the decrease in Triclosan over time was quantitated as described in Section C. Particularly, six monolayer films were tested: 1, 2, 3, 4, 5, and 6. Time points were taken at 0 to 14 day intervals, and the results are shown in the plurality of line graphs illustrated in FIG. 1.

Particularly, monolayer films 1, 2, 3, 4, 5, and 6 are represented by a square (▪), triangle (▴), star (★), circle (), diamond (⋄), and line (—), respectively. From the results, film 5 (COC) retained the highest percent Triclosan in solution over the time course. Thus, from the data illustrated in FIG. 1, Film 5 scalped the least amount of Triclosan, compared to the other monolayer films tested over the 14 day trial period.

### Example 2

### Monolayer Film 140-Hour Time Study of Triclosan Scalping

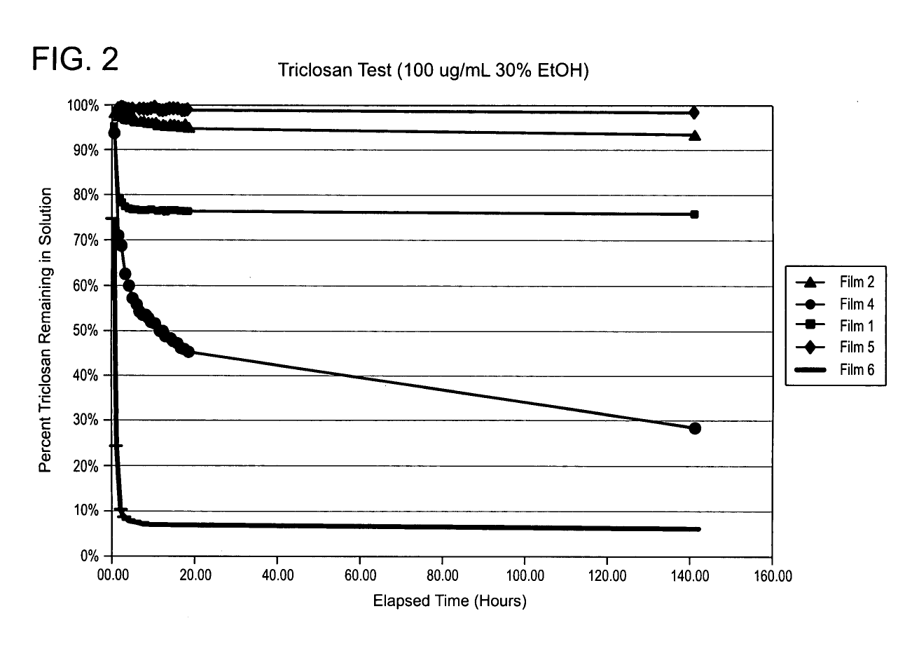

An approximately 100 μg/mL solution of Triclosan was prepared by dissolving Triclosan in 30% ethanol. The solution was then exposed to a plurality of monolayer films to be tested for scalping, and the decrease in Triclosan over time was quantitated as described in Section C. Time points were taken at 0 to 140 hour intervals, and the results are shown in the plurality of line graphs illustrated in FIG. 2.

Particularly, in the plurality of line graphs illustrated in FIG. 2, monolayer films 2, 4, 1, 5, and 6 are represented by triangle (▴), circle (), square (▪), diamond (⋄), and line (—), respectively. From the results shown in FIG. 2, Film 5 (COC) retained the highest percent Triclosan over the time course. Thus, from the data illustrated in FIG. 2, Film 5 scalped the least amount of Triclosan, compared to the other monolayer films tested over the 140 hour trial period.

### Example 3

### Triclosan Scavenging Results After 20 Hours

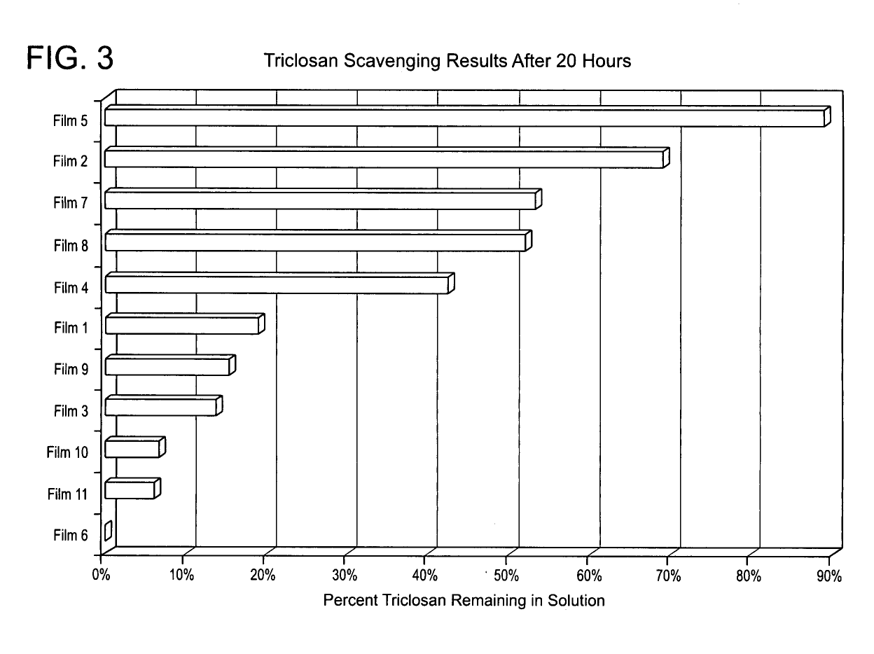

An approximately 10 μg/mL solution of Triclosan was prepared by dissolving Triclosan in 10% ethanol. The solution was then exposed to a plurality of monolayer films to be tested for scalping, and the decrease in Triclosan over time was quantitated as described in Section C. Particularly, 11 monolayer films were prepared: 5, 2, 7, 8, 4, 1, 9, 3, 10, 11, and 6. Measurements were taken after 20 hours, and the results are shown in the bar graph of FIG. 3.

From the results shown in FIG. 3, Film 5 (COC) retained the highest percent Triclosan in solution over the time course. Thus, from the data illustrated in FIG. 3, Film 5 scalped the least amount of Triclosan, compared to the other monolayer films tested over the 140 hour trial period.

In addition, the COC blend monolayer films (Films 7 and 8, 50/50 COC/LDPE and 50/50 COC/EAA, respectively) exhibited less scalping compared to Film 4 (PLA), Film 1 (LDPE), Film 9 (HDPE), Films 3 and 10 (EAA), Film 11 (APA), and Film 6 (Nylon).

### Example 4

### Monolayer Film 21-Hour Time Study of Triclosan Scalping

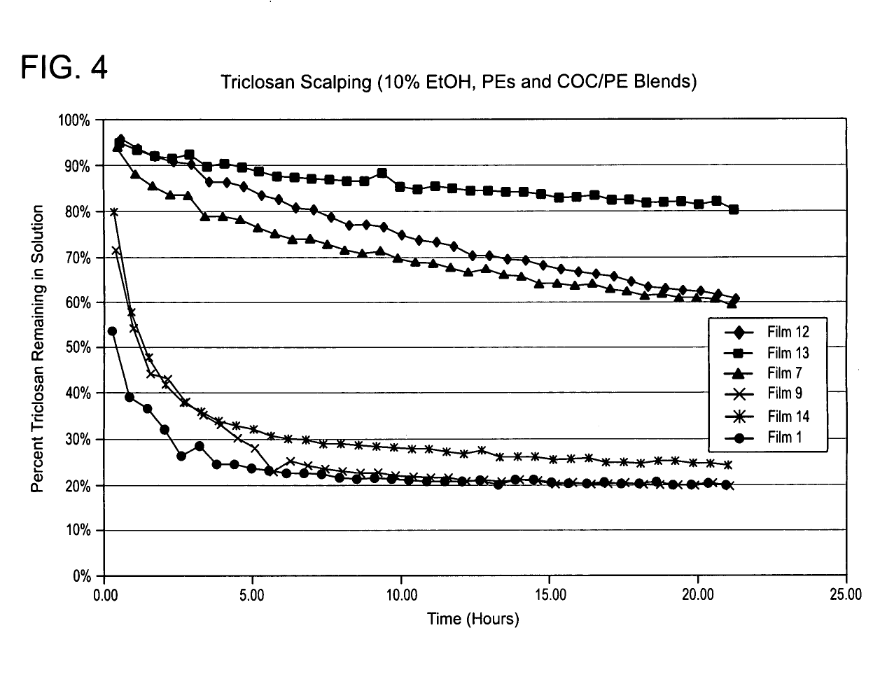

An approximately 10 μg/mL solution of Triclosan was prepared by dissolving Triclosan in 10% ethanol. The solution was then exposed to a plurality of monolayer films to be tested for scalping, and the decrease in Triclosan over time was quantitated as described in Section C. Particularly, 6 monolayer films were prepared: 12, 13, 7, 9, 14, and 1, represented by a diamond (⋄), square (▪), triangle (▴), X, star (★), and circle (), respectively. Time points were taken at 0 to 21 hours, and the results are shown in the plurality of line graphs illustrated in FIG. 4.

From the results shown in FIG. 4, Film 13 (50/50 MDPE/COC blend) retained the highest percent Triclosan in solution over the time course. Thus, from the data illustrated in FIG. 4, Film 13 scalped the least amount of Triclosan, compared to the other monolayer films tested over the 21 hour trial period.

In addition, Film 12 (50/50 HDPE/COC blend) and Film 7 (50/50 LDPE/COC blend) exhibited less scalping compared to the HDPE (Film 9), MDPE (Film 14), and LDPE (Film 1). It was unexpectedly discovered that the solution exposed to Film 13 (having a 50/50 MDPE/COC blend) retained a higher percent of Triclosan than Film 12 (having a 50/50 HDPE/COC blend).

### Example 5

### Monolayer Film 20 Hour Time Course

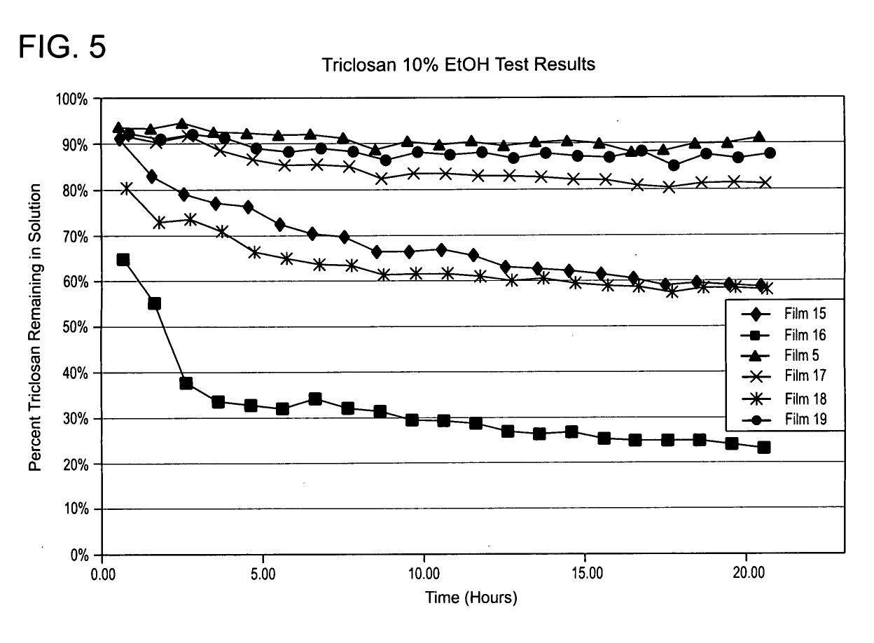

An approximately 10 μg/mL solution of Triclosan was prepared by dissolving Triclosan in 10% ethanol. The solution was then exposed to a plurality of monolayer films to be tested for scalping, and the decrease in Triclosan over time was quantitated as described in Section C. Particularly, 6 monolayer films were prepared: 15, 16, 5, 17, 18, and 19, represented by a diamond (⋄), square (▪), triangle (▴), X, star (★), and circle (), respectively. Time points were taken at 0 to 21 hours, and the results are shown in the plurality of line graphs illustrated in FIG. 5.

From the results shown in FIG. 5, Film 5 (COC) retained the highest percent Triclosan in solution over the time course. Thus, from the data illustrated in FIG. 5, Film 5 scalped the least amount of Triclosan, compared to the other monolayer films tested over the 21 hour trial period.

In addition, Films 19 (COC) and 17 (COC) also retained a high percentage of Triclosan in solution. Further, Films 18 (COC) and 15 (COC) also exhibited decreased scalping of Triclosan compared to film 16 (styrene/ethylene copolymer).

### Example 6

### Anethole Scavenging Results After 12 Hours

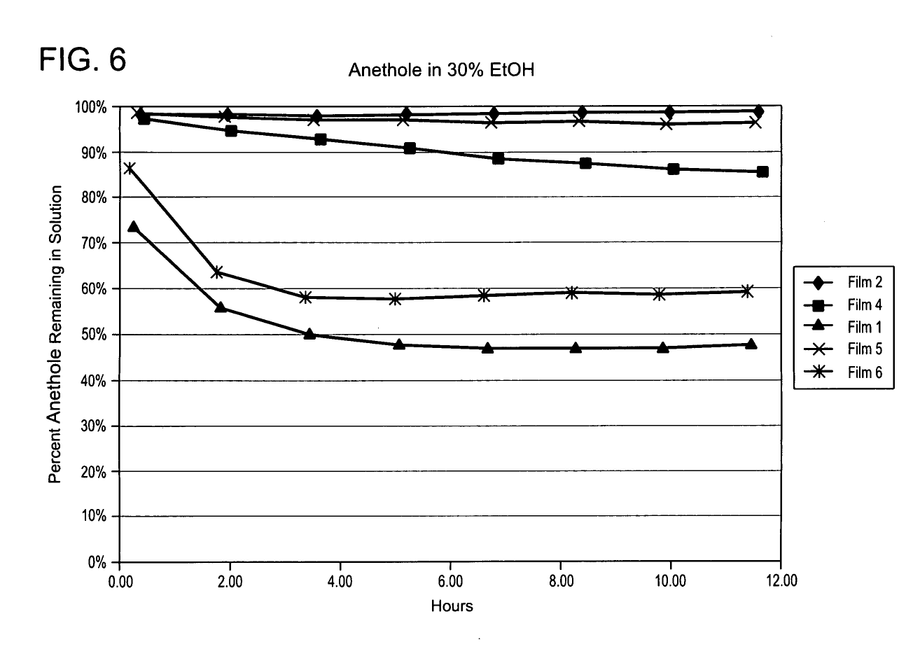

An approximately 10 μg/mL solution of Anethole was prepared by dissolving Anethole in 30% ethanol. The solution was then exposed to a plurality of monolayer films to be tested for scalping, and the decrease in concentration of Anethole over time was quantitated as described in Section D. Particularly, 5 monolayer films were prepared: 2, 4, 1, 5, and 6, represented by a diamond (⋄), square (▪), triangle (▴), X, and star (★), respectively. Time points were taken at 0 to 11 hours, and the results are shown in the plurality of line graphs illustrated in FIG. 6.

From the results shown in FIG. 6, Films 2 (BAREX®) and 5 (COC) retained the highest percent Anethole in solution over the time course. Thus, from the data illustrated in FIG. 6, Films 2 and 5 scalped the least amount of Anethole, compared to the other monolayer films tested over the 11 hour time course.

### Example 7

### BHT Scavenging Results After 12 Hours

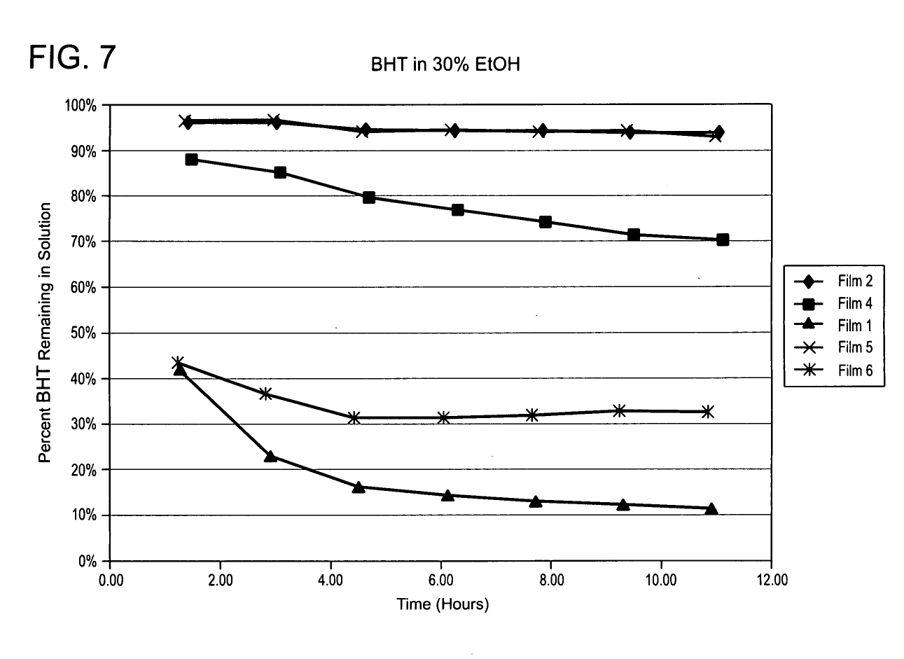

An approximately 10 μg/mL solution of butylated hydroxytoluene (“BHT”) was prepared by dissolving in 30% ethanol. The solution was then exposed to a plurality of monolayer films to be tested for scalping, and the decrease in concentration of BHT over time was quantitated as described in Section E. Particularly, 5 monolayer films were prepared: 2, 4, 1, 5, and 6, represented by a diamond (⋄), square (▪), triangle (▴), x, and a star (★), respectively. Time points were taken at 0 to 11 hours, and the results are shown in the plurality of line graphs illustrated in FIG. 7.

From the results shown in FIG. 7, Films 2 (BAREX®) and 5 (semi-crystalline COC) retained the highest percent BHT in solution over the time course. Thus, from the data illustrated in FIG. 7, Films 2 and 5 scalped the least amount of BHT, compared to the other monolayer films tested over the 12 hour time course.

### Example 8

### Preliminary Testing of Monolayer Films in Limonene, Menthol, Anethole and Triclosan

Five replicates of Film 1 (LDPE), and single replicates of Films 2 (BAREX®), 6 (Nylon), and 5 (semi-crystalline COC) were prepared and placed into a toothpaste formulation for preliminary testing, prior to conducting a full scale time study. The samples were placed into jars of toothpaste and incubated at 40° C. Total Plus Total Blue Whitening Gel Toothpaste® and 1″×5″ strips were used. The sample analysis was conducted as set forth in Section F (“Scalping of Triclosan and Flavor Components from Toothpaste”) above.

Upon removal of the films from the toothpaste after 13 days, Film 5 was observed to be in several pieces, while the other films remained intact. After detailed examination of the toothpaste components, the presence of Limonene was suspected as being problematic. After investigation, it was determined that Limonene is an excellent solvent for Film 5, as confirmed by the full dissolution of Film 5 in 100% Limonene solution.

The film pieces were then rinsed with water and extracted overnight in methylene chloride, as in the previous experiments. The amount of Limonene, Menthol, Anethole, and Triclosan scalped was then quantitated. Despite the degradation of Film 5, it was also extracted, and the numbers reported below are based on the remaining area extracted. Table 4 represents the amount of each compound (Limonene, etc.) scalped by the five Film 1 replicates, and Table 5 represents the amount of each compound scalped by the remaining films.

It was concluded that the presence of Limonene can cause swelling of the COC and can actually cause greater scalping of Triclosan and other flavor compounds. It was concluded that either Limonene would have to be removed from the toothpaste component or another solution would be required. As set forth in detail herein above, Limonene is a non-polar compound. It is believed the nonpolar nature of Limonene harmed the COC.

TABLE 4
Film 1 Replicates After Exposure to Toothpaste
for 13 Days at 40° C.

| Replicate | Limonene | Menthol | Anethole | Triclosan |
|---|---|---|---|---|
| A | ND¹ | 97 | 151 | 168 |
| B | 12 | 127 | 186 | 189 |
| C | ND | 71 | 142 | 194 |
| D | ND | 66 | 149 | 194 |
| E | ND | 78 | 154 | 175 |
| Average | N/A | 88 | 157 | 184 |
| % RSD² | N/A | 29 | 11 | 7 |

¹ND = no data
²RSD = relative standard deviation

TABLE 5
Monolayer Films After Exposure to Toothpaste
for 13 Days at 40° C.

| Sample | Limonene | Menthol | Anethole | Triclosan |
|---|---|---|---|---|
| Film 1 (LDPE) | 2 | 88 | 157 | 184 |
| Film 5 (COC) | 435 | 2260 | 1060 | 1900 |
| Film 2 (BAREX ®) | 12 | 0 | 0 | 26 |
| Film 6 (nylon) | 16 | 522 | 140 | 1870 |

In view of the results above, single replicates of Films 14, 34, 13, 35, 5, 19, and 17 were prepared and the amount of each compound (Limonene, etc.) scalped by the replicates were determined after 4 days using the protocol set forth above with regard to the 13-day samples. Table 6 illustrates the amount Limonene, Menthol, Anethole, and Triclosan scalped by the films.

TABLE 6
COC Blends and Other Polymers After Exposure
to Toothpaste for 4 Days at 40° C.

| Sample | Limonene | Menthol | Anethole | Triclosan |
|---|---|---|---|---|
| Film 14 | 0 | 30 | 74 | 148 |
| (MDPE) | | | | |
| Film 34 (75/25 | 6 | 95 | 107 | 212 |
| MDPE/COC) | | | | |
| Film 13 (50/50 | 226 | 1230 | 561 | 1200 |
| MDPE/COC) | | | | |
| Film 35 (25/75 | 316 | 1540 | 710 | 1360 |
| MDPE/COC) | | | | |
| Film 5 (COC) | 243 | 1290 | 568 | 1230 |
| Film 19 | 0 | 0 | 29 | 0 |
| (amorphous | | | | |
| COC) | | | | |
| Film 17 (semi- | 33 | 248 | 111 | 311 |
| crystalline | | | | |
| COC) | | | | |

Thus, it appears that if the COC layer is in direct contact with the toothpaste, the COC scalps less Triclosan, but the solubilizing power of the Limonene in toothpaste negates such benefit. It also appears that blending of the COC with PE fails to eliminate the problem.

### Example 9

### Triclosan Scalped from Toothpaste at 10, 19, and 45 Days

Five films (20, 21, 22, 23, and 24) were pressed into foil and formed into pouches. The pouches were filled with about 75-80 grams of Total® Plus Whitening Blue Gel Toothpaste (available from Colgate-Palmolive Company, New York, N.Y., United States of America). The pouches were sealed and held at 40° C. Four pouches were prepared for each formulation. Two pouches were removed at the 10 day time point, and subsequent measurements were done on single pouches at 19 days and 45 days.

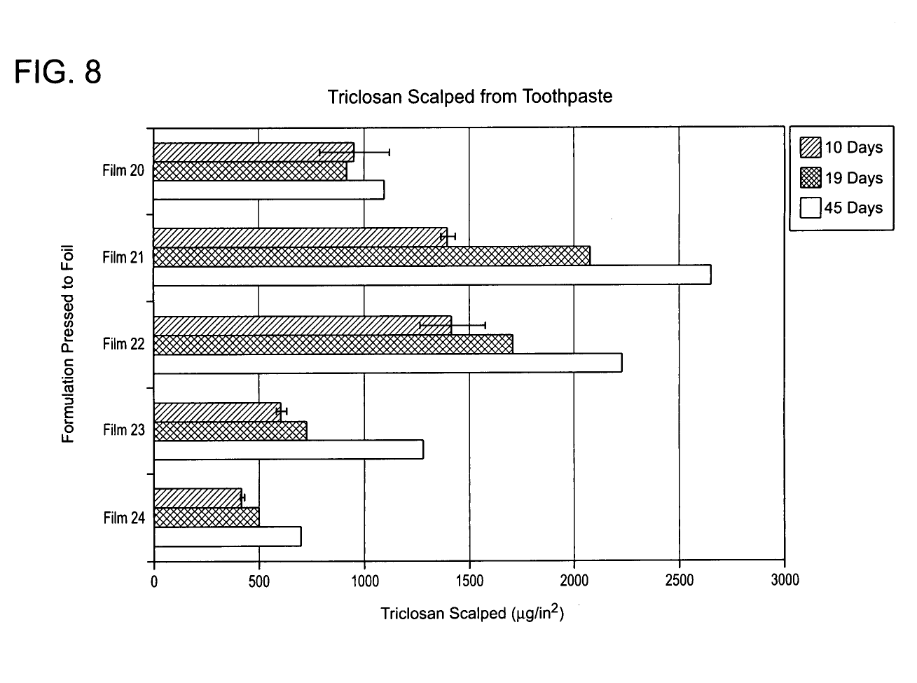

FIG. 8 is a bar graph illustrating the amount of Triclosan scalped from each film at the end of 10, 19, and 45 days. From the data illustrated in FIG. 8, Films 24 and 23 (both 50/50 COC/MDPE core films) showed the least amount of Triclosan scalping compared to the other films tested. Particularly, films 23 and 24 showed lower scalping compared to Film 22 (50/50 COC/MDPE). Thus, it was concluded that COCs with higher Tg are likely to give lower scalping.

### Example 10

### Menthol Scalped from Toothpaste at 10, 19, and 45 Days

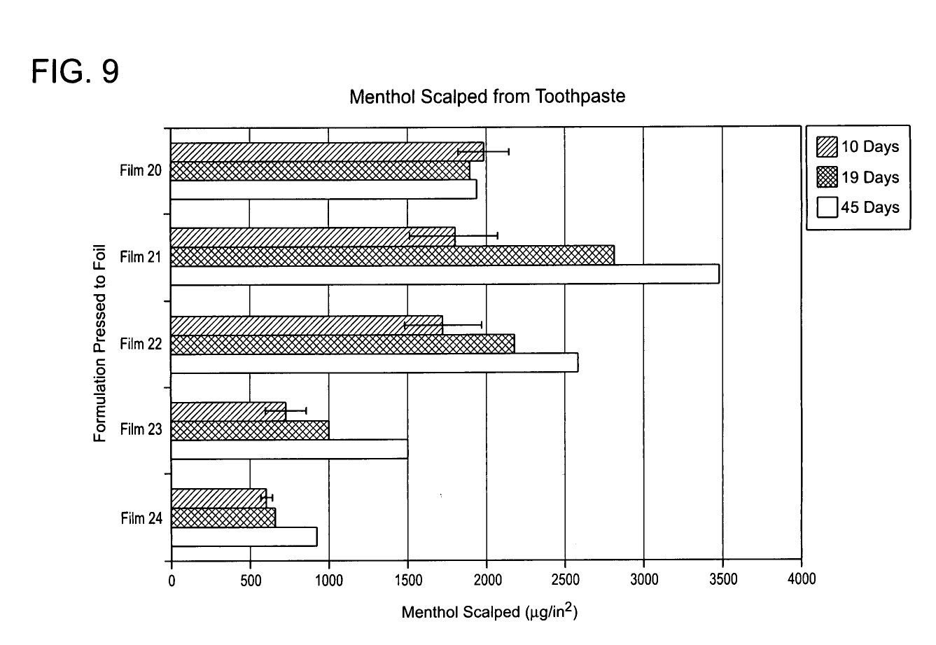

Five films (20, 21, 22, 23, and 24) were pressed into foil, formed into pouches, and tested as done in Example 9. FIG. 9 is a bar graph illustrating the amount of Menthol scalped from each film at the end of 10, 19, and 45 days. From the data illustrated in FIG. 9, Films 24 and 23 (both 50/50 COC/MDPE core films) showed the least amount of Menthol scalping compared to the other films tested. Particularly, films 23 and 24 showed lower scalping compared to Film 22. It was thus concluded that COCs with higher Tg are likely to give lower scalping.

### Example 11

### Anethole Scalped from Toothpaste at 10, 19, and 45 Days

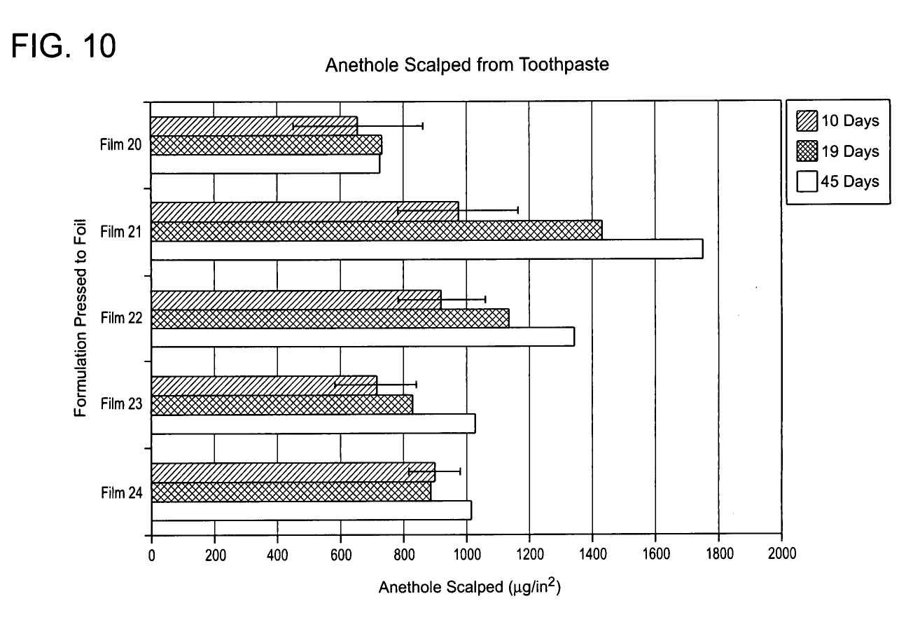

Five films (20, 21, 22, 23, and 24) were pressed into foil, formed into pouches, and tested as done in Example 9. FIG. 10 is a bar graph illustrating the amount of Anethole scalped from each formulation at the end of 10, 19, and 45 days.

### Example 12

### Limonene Scalped from Toothpaste at 10.19. and 45 Days

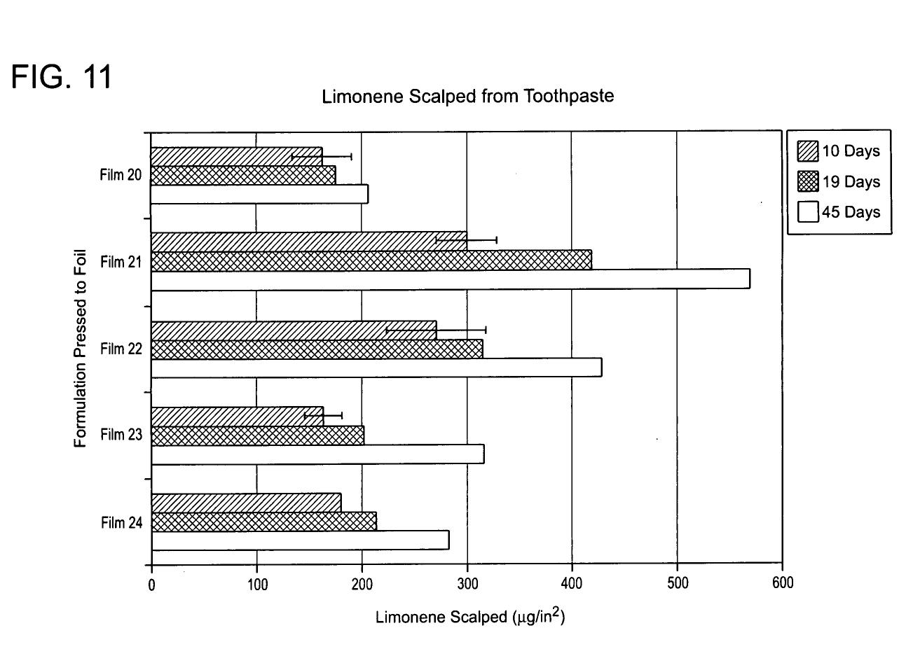

Five films (20, 21, 22, 23, and 24) were pressed into foil, formed into pouches, and tested as done in Example 9. FIG. 11 is a bar graph illustrating the amount of Limonene scalped from each formulation at the end of 10, 19, and 45 day time points.

### Example 13

### Triclosan Scalped from Toothpaste at 10 and 21 Days

Ten films (26, 23, 24, 27, 28, 29, 30, 31, 32, and 33) were pressed into foil and formed into pouches. The pouches were filled with about 75-80 grams of Total® Plus Whitening Blue Gel Toothpaste (available from Colgate-Palmolive Company, New York, N.Y., United States of America). The pouches were sealed and held at 40° C. Four pouches were prepared for each formulation. Two pouches were removed at the 10 day time point, and subsequent measurements were done on single pouches at 21 days.

After removal from the oven, pouches were cut open and the toothpaste was removed by rinsing with water until no visible signs of toothpaste remained. 1″×5″ strips were cut from each pouch and extracted overnight in 15 mL of methylene chloride at 40° C. Extracts were then filtered and analyzed using gas chromatography as described in Section F. Films were extracted for an additional 24 hours to verify completeness of the extraction.

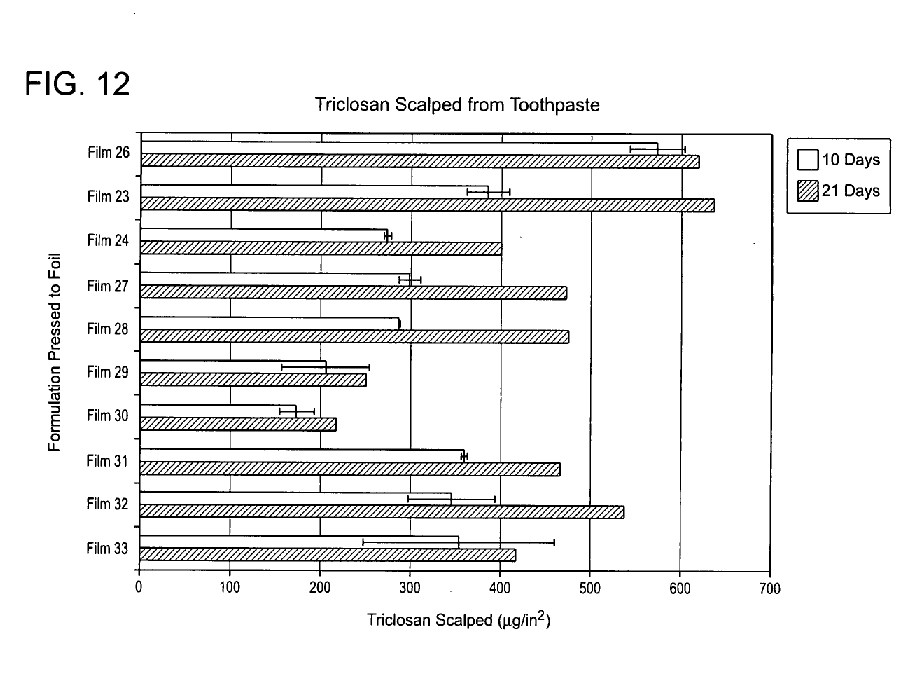

FIG. 12 is a bar graph illustrating the amount of Triclosan scalped from toothpaste at 10 and 21 day time points for each film. From the data illustrated in FIG. 12, Films 29 and 30 (both 75/25 COC/MDPE core films) exhibited the least amount of Triclosan scalping. Films 24, 27, and 28 (all 50/50 COC/MDPE core films) also exhibited decreased scalping of Triclosan compared to the control (Film 26, a 2-layer film comprising MDPE and EAA) and the other samples tested.

Unexpectedly, films with blends of 75/25 COC/MDPE in the core layer showed lower scalping compared to films with 100% COC in the core layers. These blends also showed lower scalping compared to films containing 50/50 COC/MDPE blends in the core layer. The results are believed to indicate that the 100% COC core does not bond as well to the adjacent film layers.

### Example 14

### Menthol Scalped from Toothpaste at 10 and 21 Days

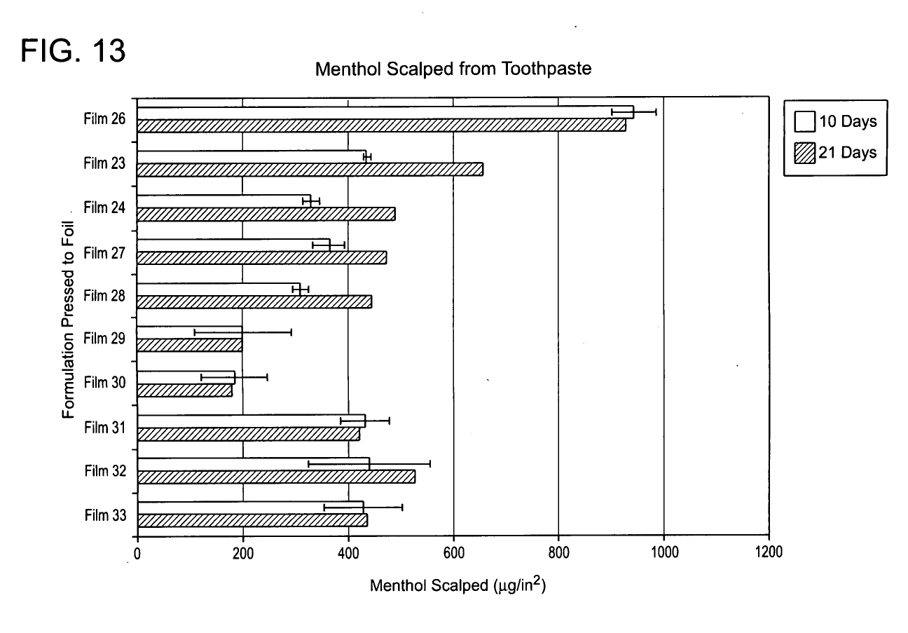

Ten films (26, 23, 24, 27, 28, 29, 30, 31, 32, and 33) were pressed into foil, formed into pouches, and tested as done in Example 13. FIG. 13 is a bar graph illustrating the amount of Menthol scalped from each film at the end of 10 and 21 day time points. From the data illustrated in FIG. 13, Films 29 and 30 (both 75/25 COC/MDPE core films) exhibited the least amount of Menthol scalping. In addition, Films 24, 27, and 28 (all 50/50 COC/MDPE core films) exhibited decreased Menthol scalping compared to control Film 26 (a 2-layer film comprising MDPE and EAA).

Unexpectedly, films with blends of 75/25 COC/MDPE in the core layer showed lower scalping compared to films with 100% COC in the core layers. These blends also showed lower scalping compared to films containing 50/50 COC/MDPE blends in the core layer. The results are believed to indicate that the 100% COC core does not bond as well to the adjacent film layers

### Example 15

### Limonene Scalped from Toothpaste at 10 and 21 Days

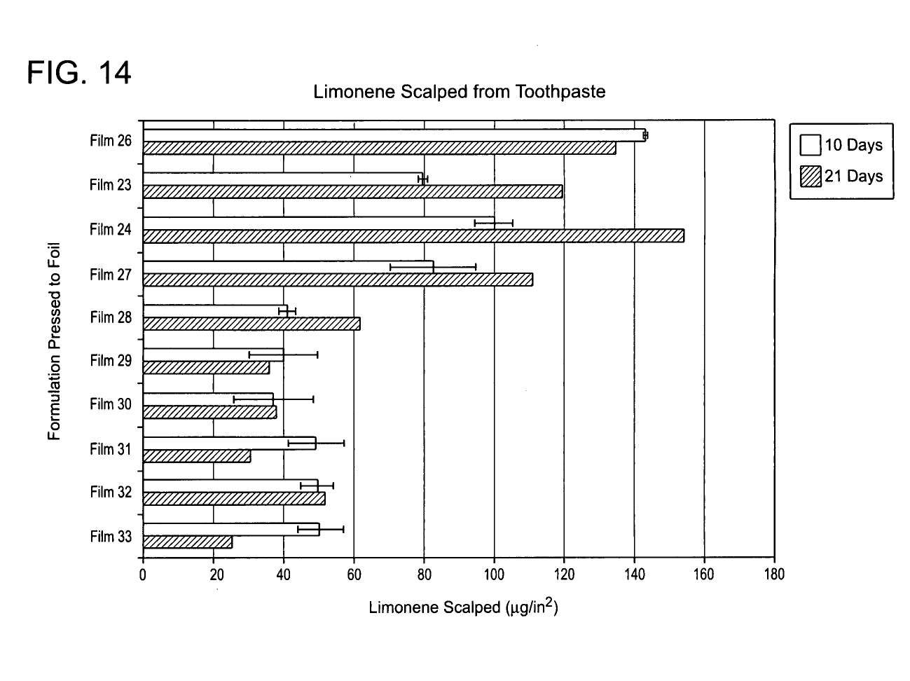

Ten films (26, 23, 24, 27, 28, 29, 30, 31, 32, and 33) were pressed into foil, formed into pouches, and tested as done in Example 13. FIG. 14 is a bar graph illustrating the amount of Limonene scalped from each film at the end of 10 and 21 day time points. From the data illustrated in FIG. 14, Films 28, 29, and 30 (all 75/25 COC/MDPE core films) and Films 31, 32, and 33 (all COC core films) exhibited the least amount of Limonene scalping.

Unexpectedly, films with blends of 75/25 COC/MDPE in the core layer and 100% COC in the core layer showed lower scalping compared to films 23, 24, and 27 (all 50/50 COC/MDPE core layers). Thus, blends with 100% COC and 75% COC/MDPE core layers appear to have lower scalping characteristics compared to blends with 50/50 COC/MDPE core layers.

### Example 16

### Anethole Scalped from Toothpaste at 10 and 21 Days

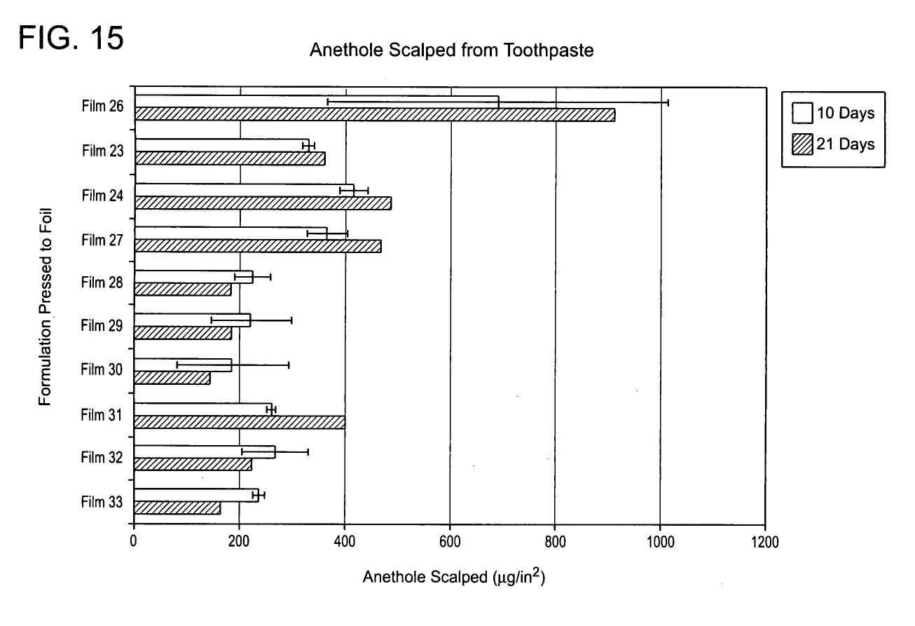

Ten films (26, 23, 24, 27, 28, 29, 30, 31, 32, and 33) were pressed into foil, formed into pouches, and tested as done in Example 13. FIG. 15 is a bar graph illustrating the amount of Anethole scalped from each film at the end of 10 and 21 day time points. From the data illustrated in FIG. 15, Films 28, 29, and 30 (all 75/25 COC/MDPE core films) and Films 31, 32, and 33 (all COC core films) exhibited the least amount of Anethole scalping.

What is claimed is:

1. A packaging film comprising:
(a) a sealant layer comprising
i. at least 25 weight % semi-crystalline cyclic olefin copolymer, amorphous cyclic olefin copolymer, cyclic olefin homopolymer, or combinations thereof, based on the total weight of the layer; and
ii. not more than 75 weight % medium density polyethylene, based on the total weight of the layer; or
(b) a layer adjacent to the sealant layer comprising
i. at least 25 weight % semi-crystalline cyclic olefin copolymer, amorphous cyclic olefin copolymer, cyclic olefin homopolymer, or combinations thereof, based on the total weight of the layer; and
ii. not more than 75 weight % medium density polyethylene, based on the total weight of the layer; or
(c) both (a) and (b);
wherein the film is in contact with a product containing polar cyclic compounds and the film scalps not more than about 1 to 90% of said polar cyclic compounds.

2. The film of claim 1, wherein the semi-crystalline cyclic olefin copolymer is selected from the group comprising: Topas® 8007, Topas® 6013, Topas® 5013, Topas® 6017, Topas® 6015, and combinations thereof.

3. The film of claim 1, wherein the amorphous cyclic olefin copolymer or cyclic olefin polymer is selected from the group comprising: Zeonor® 1020R, Zeonor® 1060R, Zeonor® 1420R, Zeonor® 1600R, Zeonex® E48R, Zeonex® 480, Zeonex® 480R, Zeonex® RS820, and combinations thereof.

4. The film of claim 1, wherein the film scalps not more than about 1%, 2%, 3%, 4%, 5%, 10%, 15%, 20%, 25%, 30%, 35%, 40%, 45%, 50%, 55%, 60%, 65%, 70%, 75%, 80%, 85%, or 90% of said polar cyclic compounds.

5. The film of claim 1, wherein the film is a monolayer film.

6. The film of claim 1, wherein the film is a multilayer film.

7. The film of claim 1, wherein the film is laminated to a member of the group consisting of: metal foil, a polymeric material, paper product, or combinations thereof.

8. The film of claim 7, wherein the metal foil is selected from the group consisting of: copper, aluminum, gold, silver, bronze, brass, and combinations thereof.

9. A toothpaste tube comprising a barrel made from the film of claim 1.

10. A method of scalping polar cyclic compounds from a packaged product, the method comprising packaging the product in a packaging film comprising:
(a) a sealant layer comprising:
i. at least 25 weight % semi-crystalline cyclic olefin copolymer, amorphous cyclic olefin copolymer, cyclic olefin homopolymer, or combinations thereof, based on the total weight of the layer; and
ii. not more than 75 weight % medium density polyethylene, based on the total weight of the layer; or
(b) a layer adjacent to the sealant layer comprising:
i. at least 25 weight % semi-crystalline cyclic olefin copolymer, amorphous cyclic olefin copolymer, cyclic olefin homopolymer, or combinations thereof, based on the total weight of the layer; and
ii. not more than 75 weight % medium density polyethylene, based on the total weight of the layer; or
(c) both (a) and (b);
wherein the film scalps not more than about 1 to 90% of said polar cyclic compounds in said packaged product.

11. The method of claim 10, wherein the semi-crystalline cyclic olefin copolymer is selected from the group comprising: Topas® 8007, Topas® 6013, Topas® 5013, Topas® 6015, Topas® 6017, and combinations thereof.

12. The method of claim 10, wherein the amorphous cyclic olefin copolymer or cyclic olefin polymer is selected from the group comprising: Zeonor® 1020R, Zeonor® 1060R, Zeonor® 1420R, Zeonor® 1600R, Zeonex® E48R, Zeonex® 480, Zeonex® 480R, Zeonex® RS820, and combinations thereof.

13. The method of claim 10, wherein the film scalps not more than about 1%, 2%, 3%, 4%, 5%, 10%, 15%, 20%, 25%, 30%, 35%, 40%, 45%, 50%, 55%, 60%, 65%, 70%, 75%, 80%, 85%, or 90% of said polar cyclic compounds.

14. The method of claim 10, wherein the film is a monolayer film.

15. The method of claim 10, wherein the film is a multilayer film.

16. The method of claim 10, wherein the film is laminated to a member selected from the group consisting of: metal foil, a polymeric material, a paper product, or combinations thereof.

17. The method of claim 16, wherein the metal foil is selected from the group consisting of: copper, aluminum, gold, silver, bronze, brass, and combinations thereof.

18. A packaged product comprising a film surrounding a product containing polar cyclic compounds, wherein the film comprises:
(a) a sealant layer comprising
i. at least 25 weight % semi-crystalline cyclic olefin copolymer, amorphous cyclic olefin copolymer, cyclic olefin homopolymer, or combinations thereof, based on the total weight of the layer; and
ii. not more than 75 weight % medium density polyethylene, based on the total weight of the layer; or
(b) a layer adjacent to the sealant layer comprising
i. at least 25 weight % semi-crystalline cyclic olefin copolymer, amorphous cyclic olefin copolymer, cyclic olefin homopolymer, or combinations thereof, based on the total weight of the layer; and
ii. not more than 75 weight % medium density polyethylene, based on the total weight of the layer; or
(c) both (a) and (b);
wherein the film scalps not more than about 1 to 90% of said polar cyclic compounds in said packaged product.

19. The package of claim 18, wherein the semi-crystalline cyclic olefin copolymer is selected from the group comprising: Topas® 8007, Topas® 6013, Topas 50130, Topas® 6015, Topas® 6017, and combinations thereof.

20. The package of claim 18, wherein the amorphous cyclic olefin copolymer or cyclic olefin polymer is selected from the group comprising: Zeonor® 1020R, Zeonor® 1060R, Zeonor® 1420R, Zeonor® 1600R, Zeonex® E48R, Zeonex® 480, Zeonex® 480R, Zeonex® RS820, and combinations thereof.

21. The package of claim 182, wherein the package scalps not more than about 1%, 2%, 3%, 4%, 5%,10%,15%, 20%, 25%, 30%, 35%, 40%, 45%, 50%, 55%, 60%, 65%, 70%, 75%, 80%, 85%, or 90% of said polar cyclic compounds.

22. The package of claim 18, wherein the film is a monolayer film.

23. The package of claim 18, wherein the film is a multilayer film.

24. The package of claim 18, wherein the film is laminated to a member selected from the group consisting of: metal foil, a polymeric material, a paper product, or combinations thereof.

25. The package of claim 23, wherein the metal foil is selected from the group consisting of: copper, aluminum, gold, silver, bronze, brass, and combinations thereof.
